(19) United States
(12) Patent Application Publication
(10) Pub. No.: US 2026/0276969 A1
(43) Pub. Date: Sep. 17, 2026

(54) STABILIZATION SYSTEM AND METHOD FOR IMAGING SCENES HAVING APPARENT MOTION

(71) Applicant: Urugus S.A., Montevideo (UY)

(72) Inventors: Pablo Manuel Jais, Barcelona (ES); Gerardo Gabriel Richarte, Barcelona (ES); Mariano Ruben Sternheim Misuraca, Barcelona (ES); David Ivan Vilaseca, Barcelona (ES); Agustina Pose, Barcelona (ES); Emiliano Kargieman, Barcelona (ES)

(21) Appl. No.: 19/120,030

(22) PCT Filed: Oct. 6, 2023
(86) PCT No.: PCT/US2023/076192

§ 371 Date: Apr. 10, 2025

(30) Foreign Application Priority Data
Oct. 10, 2022 (EP) 22382962.3
Apr. 6, 2023 (EP) 23382334.3

(51) Int. Cl. G02B 23/02; G02B 27/64; H04N 23/68; H04N 23/743

(52) U.S. Cl. CPC G02B 23/02; G02B 27/646; H04N 23/6811; H04N 23/685; H04N 23/743

(57) ABSTRACT

Systems, methods and devices for imaging scenes in apparent motion are provided, specifically, an apparatus comprising: at least one area imaging device; at least one stabilizing optical element configured to receive light and reflect at least part of the received light; a positioning mechanism configured to move at least one of the at least one area imaging device along a first tracking axis or the at least one stabilizing optical element along a second tracking axis; and a control module configured to control the positioning mechanism to move at least one of the at least one area imaging device along the first tracking axis or the at least one stabilizing optical element along the second tracking axis.

### CROSS REFERENCE TO RELATED APPLICATION

This patent application claims the benefit of and priority to the European Patent Application No. 22382962.3, filed Oct. 10, 2022, entitled “STABILIZATION SYSTEM AND METHOD FOR IMAGING SCENES HAVING APPARENT MOTION” and European Patent Application No. 23382334.3, filed Apr. 6, 2023, entitled “STABILIZATION SYSTEM AND METHOD FOR IMAGING SCENES HAVING APPARENT MOTION” which are hereby incorporated herein in their entirety by reference

### TECHNICAL FIELD

The present disclosure relates generally to systems and methods for imaging scenes having apparent motion. More particularly, the present disclosure is related to systems and methods for stabilization for imaging scenes having apparent motion.

### BACKGROUND

Systems for imaging scenes in apparent motion have existed for a long time. One of the main challenges when imaging scenes in apparent motion is to provide image stabilization to prevent motion blur. This becomes even more challenging for space or aerial imaging systems, for which the speed of apparent motion of the scenes is especially high. Conventional satellite or aerial imaging systems have attempted to address this challenge by using linear sensors having elongated pixels or, alternatively, Time Domain Integration (TDI) sensors to compensate for apparent motion. These solutions require the imaging system to be aligned with the direction of apparent motion, and often require that the satellite system compensates for payload torques. In other systems, mirrors, lenses, or the imaging sensors themselves are moved in the direction of travel in order to compensate for the direction of travel. Still other systems utilize computationally intensive solutions to compute motion and to direct the recording medium to move in order to compensate for motion. In general, these systems are large and heavy, computationally intensive, complex, or all of the above.

Some approaches, as the ones described in WO 2015/169875 A1, at least partially overcome the problems cited above, as they allow to move an area imaging device of an imaging system along a tracking axis that is set to be substantially parallel with the direction of apparent motion of the scene, and with a speed that compensates for the speed of apparent motion. This approach allows to capture images with reduced or no blur while reducing the computational complexity of the system.

However, the approaches known in the art for performing image stabilization to prevent motion blur have configuration limitations strictly dependent on the direction of apparent motion. In the approaches known in the art, the configuration and movement of the elements of the stabilization system need to be compatible with the apparent motion, and optimal design of other aspects or elements of the system as a whole may be sacrificed in order to adapt the elements of the stabilization system to the direction and speed of the apparent motion. It would therefore be desirable to have an imaging system for scenes in apparent motion in which image blur can be avoided while decoupling the configuration and movement of the elements of the stabilization system of the imaging system from the direction and speed of the apparent motion.

### SUMMARY

Considerable advantages can be realized using the methods, apparatuses and systems described herein to image scenes with apparent motion in such a way as to eliminate or reduce blur while maintaining a simple structure that adds degrees of freedom in the design of the apparatuses and methods, by decoupling the configuration of the elements responsible for image stabilization from the direction and speed of apparent motion of the scene. This decoupling allows to separate the positioning and movement of the elements responsible for image stabilization from the direction and speed of apparent motion of the scene. This separation allows to position and move the elements responsible for image stabilization to efficiently and accurately provide image stabilization, while improving or optimizing other aspects of the system. With the features of the methods, apparatuses and systems of the present disclosure, if there are, for reasons such as constructive, mechanical, or physical reasons, axes of movement of the elements responsible for image stabilization that would be better for the overall system but would not be compatible with the movement of the apparent motion, image stabilization could be performed using stabilizing optical elements that allow to decouple or separate the stabilization system from the apparent motion. In embodiments of the present disclosure, at least one stabilizing optical element, such as a mirror, may be introduced, such that it may allow to control the direction of the light beam that reaches at least an area imaging device that captures images, providing degrees of freedom for the positioning and movement of the area imaging device and other elements of the stabilization system, which can be used to further improve other aspects of the imaging system or the apparatus in which it is located.

In certain examples, by decoupling the positioning and movement of the elements responsible for image stabilization from the apparent motion of the scene, said elements can be positioned and/or moved in such a way that they improve the thermal dissipation of the elements and of the imaging system in general.

In certain examples, by decoupling the positioning and movement of the elements responsible for image stabilization from the apparent motion, said elements can be positioned and/or moved in such a way that they allow for a more efficient use of the physical space available within the system or apparatus, such that other parts of the apparatus or system can be assembled and moved more efficiently. For example, it may be beneficial to have this freedom so that the elements responsible for the image stabilization can be positioned and/or moved such as not to interfere with electronic components, batteries, cables, propulsion systems, communication systems, or other elements. For example, it may be beneficial to have this freedom so that the elements of the stabilization system itself can be modified, increased, or new elements can be added, because the use of the space may be optimized. For example, it may be beneficial to have this freedom so that the elements of the stabilization system can be placed in a way that constraints, such as launch constraints, are met.

In certain examples, by decoupling the positioning and movement of the elements responsible for image stabilization from the apparent motion, said elements can be positioned in such a way as to better withstand launch conditions, for example so that the vibrations occurring during launch do not negatively impact the elements responsible for image stabilization.

In certain examples, by decoupling the positioning and movement of the elements responsible for image stabilization from the apparent motion, said elements can be positioned and/or moved in such a way that disturbances, which could be introduced in the system or apparatus when the elements of the stabilization system are moved back and forth in the direction of apparent motion, can be avoided. Said disturbances could be caused because large accelerations may be generated that cause a swinging motion or a pendulum effect, thereby affecting the apparatus/system's attitude. For example, depending on the structure and mass distribution of the vehicle or apparatus where the imaging system (the part of the vehicle responsible for at least the image stabilization and capture) is located, and on the principal inertial axes of the vehicle, the location and/or movement of the elements responsible for image stabilization in specific directions and of specific magnitudes may cause shocks or disturbances that may affect the attitude of the vehicle or apparatus. The methods and systems of the present disclosure may in certain examples avoid or reduce the generation of said disturbances caused by the movement of the elements responsible for image stabilization because they allow compensating for the perturbations that may be introduced by the movement of said elements. The compensation of multiple torques caused by the movement, either alone or in combination, of the moving elements of the imaging stabilization system acting on the vehicle provides rotational equilibrium, so that the vehicle is not able to acquire angular acceleration since the net torque acting on the vehicle is considerably reduced or is zero. This torque is specially relevant for imaging systems at least partially on-board moving and rotatable vehicles, such as satellites, where the imaging system has a size or mass which represents a considerable portion of the total size or mass of the vehicle or apparatus. In some cases, the principal inertial axes of the vehicle may be aligned with elements of the optical system of the imaging system, such as with the telescope, and in such cases, the direction of the principal inertial axes is aligned with the direction of the optical axis.

In certain examples, by decoupling the positioning and movement of the elements responsible for image stabilization from the apparent motion, said elements can be positioned and/or moved in such a way that the requirement of low mobile mass (low mass of the movable elements of the positioning mechanism) can be decoupled from the mass of the area imaging device. This is for example because a stabilizing optical element may be moved instead of an area imaging device, because the stabilizing optical element may have a lower mass than the area imaging device. The stabilizing optical element may have a lower mass because it has been specifically designed to have a lower mass, for example, if a mirror is used, by making it as thin as possible, or it may have a lower mass because the mass of the area imaging device is increased. In either way, the constraints placed on the design of the area imaging device, in terms of mass, can be relaxed, and more complexity in the design of the area imaging device can be achieved without it being linked to the mobile mass. With the reduction of the mobile mass of the elements for image stabilization, also a reduction in power consumption can be achieved.

The examples above show a non-limited list of applications that the decoupling of the stabilization elements from the apparent motion can have. It should be understood that examples in which said applications are combined in any way are also envisaged by the present disclosure, for example, in certain examples, certain configurations may allow to reduce disturbances in the apparatus' attitude, while allowing for a better thermal dissipation, or they may allow to make a better use of the space while reducing disturbances in the apparatus' attitude, or any combination of all of the examples. Moreover, additional applications are also envisaged within the scope of the present disclosure.

The present disclosure provides an apparatus for imaging a scene in apparent motion, the apparatus comprising: at least one area imaging device having a plurality of pixel sensors; at least one stabilizing optical element configured to receive light and reflect at least part of the received light to be received by the at least one area imaging device; a positioning mechanism configured to move at least one of the at least one area imaging device along a first tracking axis or the at least one stabilizing optical element along a second tracking axis; and a control module configured to control the positioning mechanism to move at least one of the at least one area imaging device along the first tracking axis or the at least one stabilizing optical element along the second tracking axis.

According to embodiments, the positioning mechanism is configured to move at least one of the at least one area imaging device along the first tracking axis or the at least one stabilizing optical element along the second tracking axis in one or more cycles such that at least one of the at least one area imaging device or the at least one stabilizing optical element is moved, in each of the one or more cycles, (forward) along each respective tracking axis at a tracking speed that compensates for a speed of the apparent motion.

According to embodiments, the apparatus further comprises an imaging module, wherein the control module is configured to direct at least one of the at least one area imaging device to capture at least one exposure during each of the one or more cycles to generate one or more exposures, and wherein the imaging module is configured to form an image or video of the scene based at least in part on the one or more exposures.

According to embodiments, at least one of a direction of the first tracking axis or a direction of the second tracking axis are such that, when the positioning mechanism moves at least one of the at least one area imaging device or the at least one stabilizing optical element, a net torque caused by the movement is parallel to a direction different than a direction of apparent motion of the apparatus.

According to embodiments, the control module is configured to determine at least one of the direction of the first tracking axis or the direction of the second tracking axis based at least in part on a direction towards the center of mass of the apparatus.

According to embodiments, the positioning mechanism comprises at least one linear actuator and/or at least one rotary actuator to move the at least one area imaging device, and/or at least one linear actuator and/or at least one rotary actuator to move the at least one stabilizing optical element.

According to embodiments, the control module is configured to control the positioning mechanism to move at least one of the at least one area imaging device or the at least one stabilizing optical element such that the net torque is parallel to a direction of (towards or passing through) a center of mass of the apparatus.

According to embodiments, the control module is configured to control the positioning mechanism to move the at least one area imaging device and the at least one stabilizing optical element in a synchronized manner with each other.

According to embodiments, the apparatus comprises one area imaging device and one stabilizing optical element, wherein the first tracking axis has a direction parallel to the direction of an optical axis of the apparatus, and wherein the control module is configured to control the positioning mechanism to maintain the stabilizing optical element in a fixed position such that the light is partially reflected to reach the area imaging device with a direction perpendicular to the active area of the area imaging device.

According to embodiments, the apparatus comprises one area imaging device and one stabilizing optical element, wherein the positioning mechanism comprises one rotary actuator and the control module is configured to control the rotary actuator to rotate the stabilizing optical element about at least one axis, and/or to determine the second tracking axis to move the stabilizing optical element having a direction perpendicular to the direction of an optical axis of the apparatus, and to maintain the area imaging device in a fixed position.

According to embodiments, the at least one stabilizing optical element comprises a mirror/dichroic prism/beam splitter/half-mirror configured to reflect a first part of the received light towards the at least one area imaging device, and to let a second part of the received light pass towards an additional area imaging device or another element of the apparatus, wherein the first part and the second part of the light have different frequencies from each other.

According to embodiments, the apparatus further comprises at least one optical filter including one or more filter bands, wherein the one or more filter bands are arranged as a plurality of continuously variable filter bands, in which a transmitted wavelength varies continuously across the at least one optical filter, discrete filter bands, in which each filter band allows the transmission of a wavelength range generally defined by a central wavelength, filter arrays or filter mosaics, or any combination of these, the optical filter being located before the at least one AID.

According to embodiments, the filter array comprises a repeating pattern arranged as at least one of a regular pattern of N×N filters, a regular pattern of M×N filters, or an irregular pattern of filters.

According to embodiments, the filter array comprises a repeating pattern of filters wherein each filter of the repeating pattern of filters is configured to reduce or modify the intensity of light passing through the filter so that, for each filter of the repeating pattern of filters, a pixel sensor associated with the filter receives a different amount of light, and the control module is further configured to capture exposures having different intensities, suitable to generate High Dynamic Range, HDR, images or video.

According to embodiments, the apparatus further comprises a multi-band optical filter including a plurality of filter bands, wherein when a plurality of exposures is captured, a segment of the scene is exposed through a different one of the filter bands with successive ones of the plurality of exposures.

According to embodiments, the multi-band optical filter comprises at least one filter array.

According to embodiments, the control module is further configured to direct the positioning mechanism to move at least one of the at least one area imaging device or the at least one stabilizing optical element in one or more cycles along the first tracking axis or the second tracking axis at a tracking speed that compensates for a speed of the apparent motion; set one or more exposure times for the one or more cycles; and direct the area imaging device to take one or more exposures at the one or more exposure times in the one or more cycles. Additionally or alternatively, the one or more exposure times are set at the beginning of each cycle of the one or more cycles, or at the beginning of subsets of the one or more cycles.

According to embodiments, the one or more exposures are multiple exposures and the control module is configured to set a same exposure time for each exposure of the multiple exposures within a cycle, a different exposure time for each exposure of the multiple exposures within a cycle, or a different exposure time for a subgroup of exposures of the multiple exposures within a cycle.

According to embodiments, the apparatus is all or partially on-board an aircraft or spacecraft.

The present disclosure provides a satellite system comprising: at least one area imaging device having a plurality of pixel sensors; at least one stabilizing optical element configured to receive light and reflect at least part of the received light to be received by the at least one area imaging device; a positioning mechanism configured to move at least one of the at least one area imaging device along a first tracking axis, or the at least one stabilizing optical element along a second tracking axis; one or more processors; a memory; and a plurality of programming instructions stored on the memory and executable by the one or more processors to perform acts including controlling the positioning mechanism to move at least one of the at least one area imaging device or the at least one stabilizing optical element.

According to embodiments, the positioning mechanism is configured to move at least one of the at least one area imaging device along the first tracking axis or the at least one stabilizing optical element along the second tracking axis in one or more cycles such that at least one of the at least one area imaging device or the at least one stabilizing optical element is moved, in each of the one or more cycles, (forward) along each respective tracking axis at a tracking speed that compensates for a speed of the apparent motion.

According to embodiments, the positioning mechanism is further configured to reposition at least one of the at least one area imaging device and the at least one stabilizing optical element from a first position to a second position such that the second position is offset across or along each respective tracking axis a predetermined distance from the first position; and the acts performed by the one or more processors further include directing the positioning mechanism to reposition the at least one area imaging device and/or the at least one stabilizing optical element from the first position to the second position in one or more cycles; and directing the at least one area imaging device to take at least first exposures and at least second exposures during the one or more cycles, the first exposures corresponding to the at least one area imaging device being at the first position and the second exposures corresponding to the at least one area imaging device being at the second position; and the satellite system further comprises an imaging module configured to generate an image based at least on the first exposures and the second exposures from the one or more cycles, wherein the image is at least one of a high-resolution image, a color image, and/or a High Dynamic Range, HDR, image, or a combination of these.

According to embodiments, the acts performed by the one or more processors include determining at least one of a direction of the first tracking axis or a direction of the second tracking axis based at least in part on a direction towards (or passing through) a center of mass of the satellite system.

According to embodiments, the at least one of the direction of the first tracking axis or the direction of the second tracking axis are such that the positioning mechanism moves at least one of the at least one area imaging device or the at least one stabilizing optical element causing a composed movement/net torque to be parallel to a direction different than a direction of apparent motion of the satellite system.

According to embodiments, the positioning mechanism comprises at least one linear actuator and/or at least one rotary actuator to move the at least one area imaging device, and/or at least one linear actuator and/or at least one rotary actuator to move the at least one stabilizing optical element.

According to embodiments, the acts performed by the one or more processors include controlling the positioning mechanism to move at least one of the at least one area imaging device or the at least one stabilizing optical element such that the composed movement is parallel to a direction of (towards or passing through) a center of mass of the satellite system.

According to embodiments, the acts performed by the one or more processors include controlling the positioning mechanism to move the at least one area imaging device and the at least one stabilizing optical element in a synchronized manner with each other.

According to embodiments, the satellite system comprises one area imaging device and one stabilizing optical element, wherein the first tracking axis has a direction parallel to the direction of a center of mass of the apparatus, and wherein the stabilizing optical element is maintained in a fixed position.

According to embodiments, the satellite system comprises one area imaging device and one stabilizing optical element, wherein the acts performed by the one or more processors include controlling the linear actuator to rotate the stabilizing optical element about at least one axis, and/or determining the second tracking axis to move the stabilizing optical element having a direction perpendicular to the direction towards a center of mass of the satellite system, and maintaining the area imaging device in a fixed position.

According to embodiments, the at least one stabilizing optical element comprises a beam splitter configured to reflect a first part of the received light towards the at least one area imaging device, and to let a second part of the received light pass towards an additional area imaging device or another element of the satellite system, wherein the first part and the second part of the light have different frequencies from each other.

According to embodiments, the satellite system further comprises an imaging module, wherein the acts performed by the one or more processors include directing the at least one area imaging device to take at least one exposure during each of the one or more cycles to generate one or more exposures, and wherein the imaging module is configured to form an image of the scene based at least in part on the one or more exposures.

According to embodiments, the satellite system further comprises an optical filter including one or more filter bands, wherein the one or more filter bands are arranged as continuously variable filter bands, in which a transmitted wavelength varies continuously across the at least one optical filter, discrete filter bands, in which each filter band allows the transmission of a wavelength range generally defined by a central wavelength, filter arrays or filter mosaics, or any combination of these, the optical filter being located before the at least one AID.

According to embodiments, the filter array comprises a repeating pattern arranged as at least one of a regular pattern of N×N filters, a regular pattern of M×N filters, or an irregular pattern of filters.

According to embodiments, the satellite system further comprises a multi-band optical filter including a plurality of filter bands, wherein when a plurality of exposures is captured, a segment of the scene is exposed through a different one of the filter bands with successive ones of the plurality of exposures.

According to embodiments, the multi-band optical filter comprises at least one filter array.

According to embodiments, some of the components of the satellite system may be ground-based or on-board a separate aircraft or spacecraft, with such ground-based or separate aircraft or spacecraft in communication with the satellite system. For example, the component that may be ground-based or on-board a separate aircraft or spacecraft may be at least one processor or modules which may be in communication with an apparatus on board the satellite of the satellite system that includes the at least one stabilizing optical element, the positioning mechanism and/or the at least one area imaging device, among other things.

The present disclosure provides a computer-implemented method of operating an apparatus/imaging system to image a scene having apparent motion, the method comprising the steps of: controlling a positioning mechanism of the imaging system to move at least one of at least one area imaging device along a first tracking axis or at least one stabilizing optical element along a second tracking axis; and controlling an imaging module to capture at least one exposure through the at least one area imaging device.

The present disclosure provides a computer-implemented method of operating an apparatus/imaging system to image a scene having apparent motion, the method comprising the steps of: controlling a positioning mechanism of the imaging system to move at least one of at least one area imaging device along a first tracking axis or at least one stabilizing optical element along a second tracking axis; controlling an imaging module to capture at least one exposure through the at least one area imaging device; and generating image-related results based at least in part on the at least one exposure.

According to embodiments, the method further comprises moving at least one of the at least one area imaging device or the at least one stabilizing optical element in one or more cycles such that at least one of the at least one area imaging device or the at least one stabilizing optical element is moved, in each of the one or more cycles, (forward) along the respective tracking axis at a tracking speed that compensates for a speed of the apparent motion.

According to embodiments, the method further comprises determining at least one of a direction of the first tracking axis or and a direction of the second tracking axis based at least partially on a direction towards a center of mass of the imaging system.

According to embodiments, the at least one of the direction of the first tracking axis or the direction of the second tracking axis are such that at least one of the at least one area imaging device or the at least one stabilizing optical element are moved causing a net torque to be parallel to a direction different than a direction of apparent motion of the imaging system.

According to embodiments, the method further comprises the steps of setting one or more exposure times for the one or more cycles; and directing the area imaging device to take one or more exposures at the one or more exposure times in the one or more cycles; wherein optionally the one or more exposures are multiple exposures and a same exposure time is set for each exposure of the multiple exposures within a cycle, a different exposure time is set for each exposure of the multiple exposures within a cycle, or a different exposure time is set for a subgroup of exposures of the multiple exposures within a cycle.

Further features and advantages, as well as the structure and operation of various embodiments are described in detail below, with reference to the accompanying drawings. It is noted that the invention is not limited to the specific embodiments described herein. Such embodiments are presented herein for illustrative purposes only. Additional embodiments will be apparent to persons skilled in the relevant art(s), based on the teachings contained herein.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 shows a block diagram of an example imaging system or imaging apparatus usable to image scenes having apparent motion.

FIG. 2 illustrates an isometric view of an example partial imaging system for imaging scenes in apparent motion.

FIG. 3A illustrates an exploded view of an area imaging device and a multi-band optical filter. FIG. 3B shows an isometric view of an example partial imaging system for imaging scenes in apparent motion.

FIG. 4 (4A-4F) schematically shows, in part, different arrangements of an example imaging system for scenes in apparent motion.

FIG. 5 (5A-5G) schematically shows, in part, different arrangements of an example imaging system for scenes in apparent motion.

FIG. 6 is a flow diagram showing an example overview process for image capture using an imaging system or apparatus for scenes in apparent motion.

FIG. 7 is a flow diagram showing an example process for imaging a scene that is in apparent motion.

FIG. 8 is a graph of exposures taken, plotted against time and space during the operation of the device during an image capture phase.

FIG. 9 shows a flowchart of an operation of an imaging system for imaging scenes in apparent motion.

### DETAILED DESCRIPTION OF EMBODIMENTS

The processes, systems, and devices described herein may be implemented in a number of ways. Example implementations are provided below with reference to the following figures to aid in illustration, although those examples are not meant to be taken in a limiting sense. Embodiments control the positioning mechanism of an imaging system to move along and/or align a tracking axis of at least one area imaging device (AID) and/or a tracking axis of at least one stabilizing optical element, which may be a reflective or partially-reflective optical element such as a mirror or a dichroic mirror, so as to compensate for the apparent motion of a scene to be imaged to avoid blur, while allowing to decouple the position and/or movement of at least one of the at least one AID or the at least one stabilizing optical element from the direction of apparent motion. A tracking speed of each AID and/or a tracking speed of each stabilizing optical element may be determined to compensate for the speed of apparent motion. Alternatively or additionally, embodiments control the positioning mechanism of the imaging system to move and/or align the tracking axis of some or all the AID(s) and/or some or all the reflective/transmissive stabilizing optical elements to compensate for one or more torques acting on the vehicle as a result of the movement of the some or all the AID(s) and/or some or all the reflective/transmissive optical elements, so that the vehicle or apparatus where the imaging system is located may be in rotational equilibrium reducing or diminishing the capacity of acquiring angular acceleration. A tracking axis may be a straight or a curved tracking axis, depending on whether the at least one AID and/or the at least one stabilizing optical element are to be moved along a straight or curved line or trajectory. A run length may be determined for each moving element (AID(s) and/or stabilizing optical element(s)) to enable sufficient time for one or more exposures while each moving element is moved through its run length. The run length is the distance that the moving element can be moved forward (from a start position to an end position) along a rail following the tracking axis (also known as along track), which may be straight or curved, to allow an AID to capture exposure(s), before said moving element is moved backward, generally through the fastest path possible which, in some instances, may be along track, to return from the end position to the start position. Multiple partially overlapping exposures may be captured by causing the at least one AID and/or the at least one stabilizing optical element to cycle through multiple runs along the respective tracking axis. In a single cycle, the positioning mechanism may cause the at least one AID and/or the at least one stabilizing optical element to move along the respective tracking axis according to the determined run length and tracking speed before returning to the starting position to begin the next cycle. The exposures in each successive cycle may have a determined amount of overlap, which enables the exposures to be stitched together to form an image of arbitrary length. When a multi-band optical filter is used, each segment of the image may be exposed through all bands of the multi-band optical filter during successive cycles.

By aligning the tracking axis of each moving element following a specific direction, and/or setting a tracking speed of each moving element to compensate for the speed of apparent motion, blur is eliminated or reduced while capturing the image itself, thereby reducing computational complexity of the system. In short, the at least one AID and/or the at least one stabilizing optical element is temporarily moved at a speed that is the same as that of the apparent motion, and in some instances, at a direction such that the direction of apparent motion can be compensated, for a sufficient amount of exposure time, to result in a suitable dynamic range image that is free from motion blur. The direction such that the direction of apparent motion can be compensated may be different from the direction of the apparent motion, and each moving element (at least one AID and/or at least one stabilizing optical element) may be moved in the same or different directions, whose configuration may be designed so as to avoid motion blur while optimizing other aspects of the apparatus or vehicle. If a multi-band optical filter is present, all bands of the multi-band optical filter may be present for each exposure, and each segment of the scene may be exposed through different bands of the multi-band optical filter to allow for multispectral images.

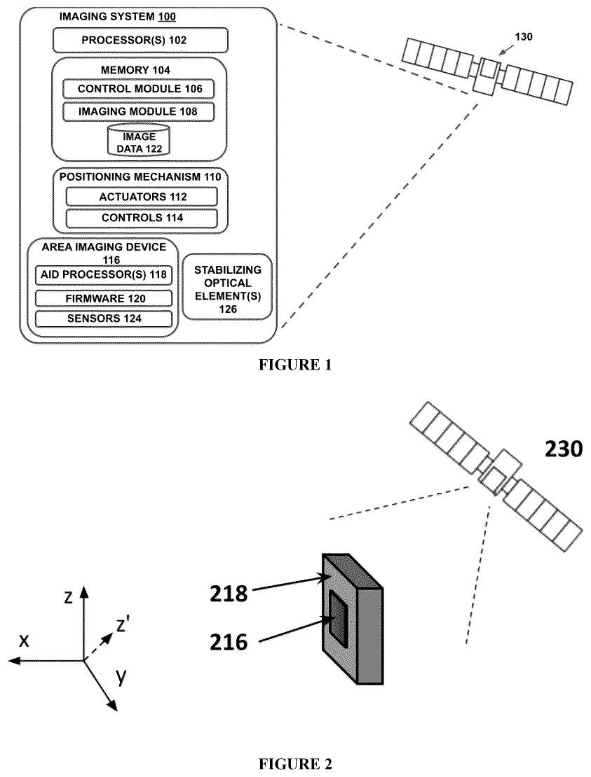

FIG. 1 shows a block diagram of an example imaging system 100 or imaging apparatus, usable to image scenes having apparent motion. The imaging system 100 may be all or partially on-board an aircraft or spacecraft, such as a satellite 130, such as a low Earth orbit (LEO) satellite. In some embodiments, some of the components of the imaging system 100 may be ground-based or on-board a separate aircraft or spacecraft, with such ground-based or separate aircraft or spacecraft in communication with the imaging system or apparatus that includes the optical system, the positioning mechanism and the area imaging device, among other things. The imaging system 100 is configured as any suitable computing device or system.

Memory 104 may store program instructions and program modules that are loadable and executable on one or more processor(s) 102, as well as data generated during execution of, and/or usable in conjunction with, these programs, such as image data, images, and so forth. Depending on the configuration and type of computing device used, the memory 104 of the imaging system 100 may include volatile memory (such as random access memory (RAM)) and/or non-volatile memory (such as read-only memory (ROM), flash memory, etc.). Memory 104 may also include additional removable storage and/or non-removable storage including, but not limited to, flash memory, magnetic storage and/or optical storage, and/or tape storage that may provide non-volatile storage of computer-readable instructions, data structures, program modules, and other data for the imaging system 100. Memory 104 is an example of non-transitory computer-readable media. Non-transitory computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory (such as NAND flash memory such as may be included in one or more nonvolatile memory cards, and including flash with both single-level and multi-level cell technologies) or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. Memory 104 includes at least a control module 106 and an imaging module 108. The control module may perform some or all of the control functions associated with capturing images or exposures in accordance with embodiments of the present disclosure. The control module 106 is executable by the one or more processors 102 to control, such as through one or more input/output interfaces, a positioning mechanism 110, including controlling actuators 112 included in the positioning system, through one or more electronic controls 114 (such as controllers, which may in turn operate actuators 112 through one or more limit switches, checks, closed loop actuator controls, and so forth) to move, position, or otherwise manipulate various mechanical aspects of the positioning mechanism 110. The actuators 112 include for example linear actuator(s) for focusing, rotary actuator(s), linear actuator(s) for tracking, sub-pixel transverse actuator(s), and other actuators and variations thereof according to various embodiments of the present disclosure.

The control module 106 is executable by the one or more processors 102 to control, such as through one or more input/output interfaces, at least one area imaging device (AID) 116. The AID 116 may be controlled to capture one or more exposures, and may be moved by the positioning mechanism 110 as will be explained elsewhere within this Detailed Description, so as to capture exposures while the AID or another element is moved (or while it stops) to compensate for the apparent motion of a scene being imaged according to various embodiments of the present disclosure. The control module 106 may be configured to control at least one stabilizing optical element 126, as explained elsewhere within this Detailed Description.

The (at least one) AID 116 may include one or more AID processors 118 and firmware 120 (stored on a suitable, non-transitory computer-readable storage medium) to perform or otherwise control various functions of the AID 116. The firmware 120 may be executable by the one or more AID processors 118 to control exposure times, time the exposure capture, determine sensor, orbit or image parameters or the like, store image data 122 on the memory 104, and so forth. The AID 116 may also include sensors 124, such as light-sensitive sensors, such as for example semiconductor components suitable to implement at least one charge coupled device (CCD), at least one complementary metal oxide semiconductor (CMOS) sensor, and/or other suitable sensor architecture on the active surface of the AID 116.

The imaging module 108 performs various image processing functions of the imaging system 100, including tone mapping to generate high dynamic range (HDR) images, a resolution enhancement algorithm to produce high-resolution images, and a stitching algorithm to generate images from multiple partially overlapping exposures, as well as other processing functions, such as blur removal, artifact removal, color enhancement, cropping, image conversion, image compression, data encryption, and so forth.

In exemplary embodiments, the firmware 120 of the AID 116 may be considered as an extension of one or both of the control module 106 and the imaging module 108, with some or all of the functions of the control module 106 and/or the imaging module 108 performed on or by the firmware 120, executing on the one or more processors 102. In some embodiments, some or all of the functions of the control module 106, the imaging module 108, and/or other functions of the firmware 120 may be implemented as logic functions on the one or more processors 102 and/or AID processors 118. For example, in some embodiments, the one or more processors 102 and/or AID processors 118 may include a central processing unit (CPU), a graphics processing unit (GPU), an application-specific integrated circuit (ASIC), a programmable logic device, such as a field programmable gate array (FPGA), a digital signal processor (DSP), a tensor processing units (TPU), any combination of these, or any other logic circuit to perform various functions, including various control functions of the control module 106. The one or more processors 102 are processors dedicated to the imaging system 100, but in many instances may be the same processors that control the system or apparatus, such as the satellite 130.

Some embodiments of the imaging systems and apparatus described herein may be employed to take images of a celestial body, such as images of the Earth, from satellites, such as satellites in Low Earth Orbit (LEO). LEO satellites orbit at speeds relative to a stationary point on the Earth that make motion blur an important issue. In satellite embodiments, the imaging system 100 includes a telescope and the AID 116 is placed after the telescope, such as at the focal plane of the telescope. The aperture and focal distance of the telescope is selected so that the exposure times of typical ground scenes are below the cycle time of the positioning mechanism.

The stabilizing optical elements 126 may comprise one or more stabilizing optical elements, such as reflecting or partially-reflecting optical elements, such as mirrors or dichroic mirrors, configured to direct and focus light, combine wavelengths, or reject specific wavelengths from the captured exposures. The stabilizing optical elements 126 may include one or more optical elements of: flat mirrors, spherical mirrors, concave or convex mirrors, semi-mirrors (dichroic prisms), retroreflectors, deformable mirrors, or other suitable types of mirrors or other optical elements such as lenses, prisms (like Risley prisms), gratings, deformable lenses, or the like. The one or more stabilizing optical elements may be located at different positions within the imaging system 100, as described elsewhere within this Detailed Description. As an example, the stabilizing optical elements 126 may be placed after the telescope, such as between the telescope and the AID(s). The stabilizing optical elements may also be part of the telescope, or may even be located before the telescope.

In some embodiments, the one or more stabilizing optical elements may comprise at least one deformable optical element, such as a deformable lens or a deformable mirror, which can be useful to perform arbitrary scanning movements, displacements or scans across the focal plane, for example to improve pointing accuracy or for image stabilization. For example, if one of the stabilizing optical elements is part of the telescope and is a deformable lens and/or a deformable mirror, in order to perform image stabilization, the deformable lens and/or deformable mirror may be use to complement the movement of another stabilizing optical element such as mirror and/or the AID 116, or it may not be necessary for the positioning mechanism to move the mirror and/or the AID 116, because the same movement in the scene may be achieved by deforming the deformable lens and/or the deformable mirror inside the telescope.

The present disclosure describes different exemplary embodiments of arrangements of imaging systems or apparatuses for scenes in apparent motion. The different exemplary embodiments comprise a different number and type of stabilizing optical elements, a different number of AIDs and different combinations of positions and/or movements of the stabilizing optical element(s) and the AID(s) in different directions (perpendicular to the optical axis, parallel to the optical axis, in other directions in between, following curved trajectories, etc.). However, all the examples have in common that they allow to avoid motion blur when imaging scenes in apparent motion while adding degrees of freedom to design the location and direction of movement of at least one of the elements responsible for image stabilization.

In one exemplary embodiment, the resulting net torque caused by the movement of all the moving elements (stabilizing optical element(s) and/or AID(s), or any other moving element), and being exerted on the apparatus, vehicle or system (e.g., the satellite), does not shake (or not above a certain threshold) or cause perturbations in the apparatus that affect or produce a change in its attitude. For example, for vehicles in which the mass or volume of the image stabilization system (positioning mechanism and moving elements (stabilizing optical element(s) and/or AID(s))) with respect to the total mass or volume of the vehicle is of a reasonable value, higher than a certain threshold, the movement of the elements of the image stabilization system may cause a perceivable shock in the vehicle. The attitude of the vehicle may be very well known, because the altitude of the orbit and other parameters may be known. However, this movement of the elements of the image stabilization system may shake the vehicle in a way that introduces a certain uncertainty as to how the vehicle is moving or where it is pointing, which may require additional correction, or which may affect the quality of the stabilization.

The principal inertial axes of the vehicle are defined as going through the center of mass, and important aspects that determine the resulting torque generated by a moving element are the position of the center of mass, and the position, mass and acceleration of each moving element (and therefore the distance and vector from the moving element to the center of mass), and the direction of the movement of each moving element, as the generated torque will be dependent on the vector product of both: the vector between the center of mass and the position of the moving element, and a vector in the direction in which the moving element is moving. As the skilled person knows, a property of the vector product is that it is minimum for parallel vectors, and maximum for perpendicular vectors. Therefore, if the image stabilization is performed by moving an element, the direction of the movement should be such that the angle between the direction of movement and the vector between the position of the element and the center of mass is less than 90 degrees, the smaller the angle, the smaller the torque. In certain examples, imaging systems have the direction of the optical axis similar or substantially aligned with one of the principal inertial axes of the vehicle. In such examples, by performing image stabilization not by moving the moving element(s) orthogonally to the main optical axis of the vehicle (in other words, in the direction of apparent motion), but with a different angle, this shock can be reduced or eliminated. When the image stabilization is performed by moving more than one moving element, by moving the moving elements in directions such that the net torque does not follow a direction orthogonal to the main optical axis, this shock can be reduced or eliminated. In other examples, the direction of the optical axis is not similar or substantially aligned with one of the principal inertial axes of the vehicle, because for example the center of mass of the vehicle is located elsewhere and the principal inertial axes are not aligned with the optical axis. In such cases, in order to minimize the net torque generated by the movement of at least one element of the image stabilization system, the position and direction of movement of the at least one element may be chosen based on the vector product as defined above, which depends on the position of the center of mass.

FIG. 2 illustrates a perspective view of an example partial imaging system for imaging scenes in apparent motion. A representation of a coordinate system to help interpret FIG. 2 is provided, where the z axis represents the axis parallel to the main optical axis of the apparatus or system. In FIG. 2, the x axis may represent the direction of motion of the vehicle or apparatus or system, and the y axis is orthogonal to both the z axis and the x axis. It should be understood that the coordinate system represented in FIG. 2 (and also in other figures) is for illustrative purposes, and it is shown with the z axis aligned with the optical axis and the x axis aligned with the direction of motion of the vehicle for reasons of simplicity and ease of explanation. It should however be understood that other orientations of the coordinate system are also envisaged in the example of FIG. 2.

In the illustrative embodiment depicted in FIG. 2, an AID 216 is represented placed on (part of) a platform 218. Platform 218 may be placed on or be a part of a positioning mechanism (not shown). Platform 218 may be placed on a tracking rail (not shown) which may also be part of the positioning mechanism, however this is not necessary, as the AID may not be configured to be moved along a tracking rail. If the AID is configured to be moved along a tracking rail, an actuator such as a linear actuator causes the platform 218 to move along the tracking rail, which in FIG. 2 could be located along a tracking axis z, but which can be located along a different direction, as is evident for the skilled person. In some embodiments, a transverse actuator that moves the platform 218 along a transverse axis that is perpendicular to the tracking axis (also known as across track) is also included. The tracking rail, if present, may include a linear actuator underneath or otherwise coupled to the platform 218. The linear actuator is operable to move the platform 218 along the tracking rail to compensate for the apparent motion of the scene being imaged. The linear actuator for tracking is sufficiently fast to displace the platform 218 at the speed of apparent motion, and to return to a start position sufficiently quickly such that another image exposure cycle can be accomplished with sufficient overlap between successively captured exposures and to increase the exposure time available to capture images. In some instances, jitter (variability in movement speed) of the linear actuator for tracking is less than a pixel of the area imaging device, or a multiple of that value, or a pixel or a multiple of a pixel, such as a small multiple, to avoid blurring of the resulting images. The linear actuator for tracking may be a piezoelectric motor, a stepper motor, or other suitable actuator or device.

In addition, the positioning mechanism may include a stand on which the tracking rail is placed, for example placed along the z axis in FIG. 2, and a focus rail on which the stand is placed, for example placed parallel to the x axis in FIG. 2. The focus rail may include a linear actuator, such as an electric motor, and may be used to focus the AID 216 by allowing the stand to move along the focus rail. In certain embodiments, when the light that enters the apparatus is folded or partially reflected by at least one stabilizing optical element, such as a mirror, the AID 216 will be positioned by the positioning mechanism so as to receive the folded or reflected rays, and the focus rail may be aligned with the direction of the rays incident on the AID. The length of the focus rail is, in embodiments, at least as long as any variations in the focus position of the AID 216. In embodiments for which the distance between the AID 216 and the focus position is expected to remain constant or to have a sufficiently small variation (such as in a satellite imaging system), the run length of focus rail may be set to a length slightly longer than the confocal length of the AID 216, such as between a few microns and a few millimeters. Where the variation in focus position is expected to be sufficiently small, the focus may be adjusted in post-processing, e.g., algorithmically, thereby enabling the manufacturing tolerances in the linear actuator to be relatively relaxed. The linear actuator need not be particularly fast, although it may be. In certain embodiments, the positioning mechanism 210 does not comprise a focus rail, and the focus position may be adjusted and fixed during manufacturing. The stand may be moved by the linear actuator along the axis of the focus rail in the embodiments in which the focus rail is present.

The AID 216 may be configured, in a simple implementation, not to be moved. In another implementation, it may be configured to be moved only in one direction, thereby requiring only one linear actuator for tracking. In such implementation, the tracking rail and the platform 218 may be oriented along a single axis, thereby only moving along one direction, for example along the z direction, wherein the light has been reflected at least partially by a stabilizing optical element such as a mirror, and the reflected light arrives at the AID along the x direction. This arrangement simplifies the complexity of the image stabilization system, and can be used in systems where the attitude of the vehicle is controlled with enough precision not to require stabilization in the axis transverse to the direction of movement (the y axis in FIG. 2), so only forward motion compensation is required. In other words, this implementation can be used in configurations in which the movement of the vehicle with respect to the planet upon which it orbits, such as the Earth, is aligned.

The AID may however also be configured to be moved in multiple directions, being controlled by at least one linear actuator and at least one rotary actuator, or several linear actuators. For example, instead of being placed directly on a stand, the tracking rail may be placed on a circular plate that rotates within a circular rail, controlled by a rotary actuator beneath or otherwise coupled to the circular plate, and the circular rail may be placed on the stand. In this case, because of the presence of the circular rail, the platform 218 is able to rotate and move along the tracking rail along a tracking axis z′. In some embodiments, a transverse actuator that moves the platform 218 along a transverse axis that is perpendicular to the tracking axis (also known as across track) is also included. The possible degree of rotation of the circular plate may be, in some embodiments, at least 180 degrees to enable orienting of the tracking rail to be at any angle, in order to account for any possible direction of apparent motion. The degree of rotation may be greater than 180 degrees in order to avoid potential problems where the direction of apparent motion happens to be near the rotational limit of the circular plate. The rotary actuator is sufficiently precise to maintain any misalignment between the tracking axis z′ and the direction of apparent motion to be less than a single pixel of the AID 216 which is positioned on the platform 218. The rotary (rotational) actuator may be a piezoelectric or stepper motor, or other suitable actuator or positioning mechanism.

In alternative embodiments, instead of a rotational actuator, two actuators, such as two linear actuators, a y actuator and a z actuator are simultaneously moved such that the AID 216 tracks the direction of apparent motion (e.g., the tracking axis z′). Determining the speeds of tracking of the y and z actuators is determined in a substantially similar way. The tracking rail may also be placed on alternative structures that allow it to be moved along the x, y, z or other directions, and/or rotated about any direction.

Improved resolution images may be obtained using along-track offset exposures (offset along the tracking axis), such as vertically offset exposures, between successive images within a cycle, across-track offset exposures (offset across the tracking axis), such as horizontally offset exposures between successive images within a cycle, or both along-track and across-track offset exposures (which may include one or more additional exposures that are both across-track and along-track offset from an original exposure, or two additional exposures one of which is across-track offset and the other of which is along-track offset from an original exposure). Along-track offset images, such as images with ½ of a pixel displacement in a direction or any other pixel displacement that is not an integer multiple of a whole pixel, enable additional resolution in the along-track direction. In these embodiments, the linear actuator for tracking repositions the AID to within an offset distance, such as ½ a pixel or a multiple thereof (or a multiple of any other pixel displacement that is not an integer multiple of a whole pixel), from the original position of a previously captured exposure. The two along-track offset images are processed as described elsewhere within this Detailed Description to produce a higher resolution image.

In some embodiments, to produce across-track offset exposures, a transverse actuator that moves the platform 218 along a transverse axis that is perpendicular to the tracking axis (across track) is also included. The run length of the transverse actuator is used, for example, for generating higher resolution images. The transverse actuator is a piezo displacement actuator or other suitable high-resolution actuator.

In some embodiments of the imaging system for use in satellites, such as in LEO satellites, the actuators are piezoelectric motors (in a variant, ultrasonic piezoelectric motors may be used instead). The rotary actuator may be a rotational motor around the x axis, used to orient the device with respect to the direction of travel. A linear motor with mechanical stabilization along the x axis may be used for focusing. The total run for the linear actuator for focusing may be enough to correct for possible variations in focus due to thermal dilation, mechanical effects, wavelength differences, etc.

Although not represented in the figures, if at least one stabilizing optical element is present which is configured to be moved by translation and/or rotation, each stabilizing optical element may be placed in a platform which may in turn be placed in a tracking rail, and one or more actuators such as linear and/or rotary actuators may cause the platform to move along the tracking rail, following straight or curved trajectories, so as to move the stabilizing optical element in similar manners to that explained above for the AID.

The (at least one) AID may also work in connection with an optical filter, which may be provided close (proximate) to or on the surface of the AID. The optical filter may comprise one or more filter bands. Filter bands are selected to cover desired wavelengths or fractions (ranges of wavelengths) of the electromagnetic spectrum, and embodiments are not limited to any particular band or bands. In some instances, the optical filter may comprise a single band. The single band may allow a continuously variable range of wavelengths throughout the band, a narrow range of wavelengths throughout the band defined by a central wavelength, or may allow the transmission of specific wavelengths or range (band) of wavelengths organized in a, generally repeating, pattern or arrangement throughout the band. For example, the optical filter may comprise a filter array or a filter mosaic, in which filters are placed over the pixel sensors of the AID throughout the band associating a pixel sensor with a specific wavelength or a band of wavelengths; and determining a repeating pattern arranged as a regular pattern of N×N filters, a regular pattern of M×N filters, or an irregular pattern of filters. It should be understood that any combination of filter arrangements over the pixels may be used. For example, a single band may comprise a 2×2 filter arrangement or pattern in which Red, Green and Blue are combined as in a RGGB Bayer filter, an arrangement including a Nir filter as in a RGBNir filter, a pattern including White (i.e. panchromatic) as in a RGBW filter, or any other possible arrangement of any other size and shape, as is readily apparent for a skilled person in the art.

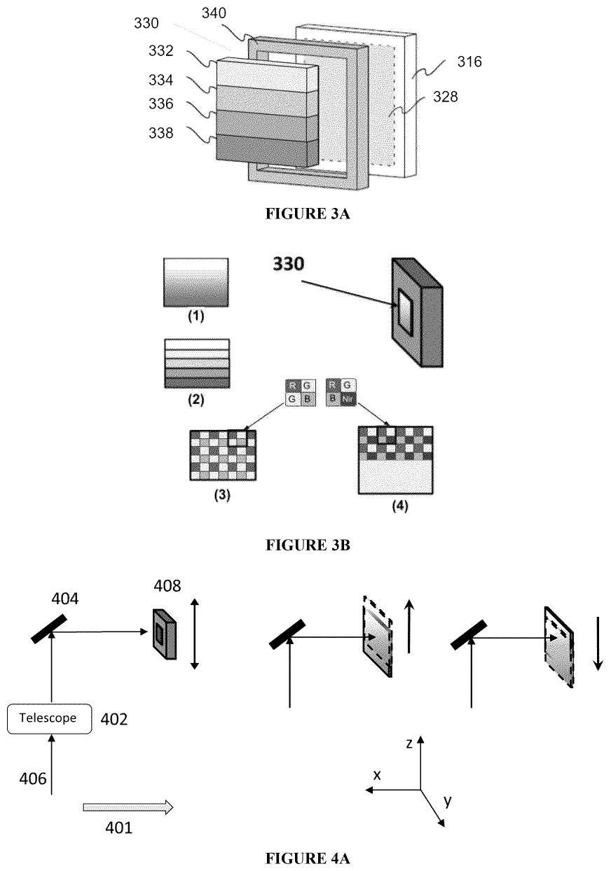

In some instances, the optical filter may comprise multiple filter bands. FIG. 3A illustrates an exploded view of an AID 316 and a multi-band optical filter 330. The multi-band optical filter 330 includes a plurality of filter bands 332, 334, 336 and 338 for use with an imaging system or apparatus for scenes in apparent motion. Embodiments may have more or fewer filter bands than the ones shown in FIG. 3A. A frame 340 holds the filter bands 332 338 in place, and is positioned over the AID 316. Filter bands are selected to cover desired fractions of the electromagnetic spectrum, and embodiments are not limited to any particular band or bands. The filter bands 332-338 may include, for example, blue, infrared, green and red bands, with another band of unfiltered coverage (i.e., a panchromatic band). The number of filter bands, and the spectral transmission of each of the filter bands 332-338 are chosen to acquire any combination of wavelengths of interest. The filter bands 332-338 may be absorption filters, interference filters, or other kinds of filters. In some embodiments of the multi-band optical filter 330 for use in satellites, such as in LEO satellites, the filter bands 332-338 comprise five aligned bandpass filters for a set of desired sections (fractions) of the electromagnetic spectrum. In one particular example, three of the filters correspond to Red, Green, and Blue (RGB) components of the visible spectrum, in order to easily compose conventional color images, with one of the remaining two bands corresponding to the whole spectrum of visible light, to get intensity information, and another of the remaining bands corresponding to near infrared. In another particular example, the filter band 332 corresponds to an N×N RGGB Bayer filter, the filter band 334 corresponds to a neutral density filter, the filter band 336 corresponds to a repeating pattern of M×N Red, Green, Blue and Nir filters, and the filter band 338 corresponds to a panchromatic filter. The neutral density filter has the characteristic of reducing or modifying the intensity of all wavelengths of light equally. Hence, in some instances, instead of having a filter band 334 in which all filters within the band reduce or modify the amount of light equally, so that the corresponding pixel sensors within the band receive the same amount of light, the filter band 334 may comprise a repeating pattern of M×N neutral density filters, wherein each filter of the M×N pattern is a neutral density filter which reduces or modifies the intensity of light differently than the remaining neutral density filters of the M×N pattern, so that each of the pixel sensors associated with each of the neutral density filters of the M×N pattern receive a different amount of light. This layout is useful for capturing exposures having different intensities, suitable, for example, to generate HDR images or videos. Other numbers and combinations of filters can be useful to gather different kinds of information whether used in satellites or other types of systems. In some instances, all bands can be captured with an exposure, and in other instances only some bands or one band may be captured with an exposure, and in other instances even a fraction of a band or at least one entire band and a fraction of another band may be captured.

According to embodiments, the optical filter may include one or more filter bands, wherein when one or more exposures is captured, a segment of the scene is exposed through a different one of the one or more filter bands with successive ones of the one or more exposures. For example, a plurality of exposures may be taken in a series of cycles. Within each cycle, one or more exposures may be taken. Because the moving element(s) (i.e., at least one AID or at least one stabilizing optical element) is moved at a speed and direction that compensates for the (direction and) speed of apparent motion of the scene being imaged, the one or more exposures in each cycle is of the same scene, with no displacements between them even though they occur at different times. At the end of each cycle, the moving element is returned to the start position. The exposures taken in successive cycles are generally offset from one another by an amount previously determined. Each successive cycle results in exposures for which a segment of the scene is exposed through a different one of the filter bands. Because there is a slight offset between exposures taken in successive cycles, the number of cycles that it takes to fully image the segment of the scene through all filter bands is greater than the number of filter bands. For instance, if a multi-band optical filter of five filter bands is used, it would take more than five cycles to fully image the segment of the scene through all filter bands. Due to the offset between successive exposures, an image may be formed stitching together the overlapped exposures. Hence, after six cycles, the segment of the scene equal to the size of a single band may be stitched together. The offset between exposures of different cycles allows to stitch together the partially overlapping exposures and create an image or a video of the scene of any size. However, when multiple exposures are captured within the same cycle, an offset between exposures within the same cycle allows to create an image or video of improved resolution, high dynamic range, or coloured images using filter mosaics. The offset between intra-cycle exposures useful to generate high-resolution images or videos may be less than a pixel's distance apart or a multiple thereof in order to capture the exposures at slightly offset positions in a direction along the tracking axis (along-track direction) and/or across the tracking axis (across-track direction). The offset between intra-cycle exposures useful to generate coloured images or HDR images using filter mosaics may be based on the filter arrangement such as a pixel's distance apart or a multiple thereof, in order to capture the exposures at offset positions so that adjacent colors or neutral density filters of the filter mosaics in a direction along the tracking axis (along-track direction) and/or across the tracking axis (across-track direction) may be captured. Additionally or alternatively, when multiple exposures are captured within the same cycle, each intra-cycle exposure may have the same exposure time. However, in some embodiments, each intra-cycle exposure may have a different exposure time, in order to provide advantageous or optimal exposure times for each filter band as another manner of generating a high dynamic range image or video.

The fact that the imaging system allows to have all bands present on each exposure makes it possible to have a regulated motion of the actuator over multiple cycles which is independent from, and not limited by, the number of bands. Nevertheless, given that the at least one moving element is moved in cycles at a speed that compensates for the speed of apparent motion (during a least a portion of the cycle) and it is necessary to capture a scene in all bands of the filter, there is a direct relationship between the number of filter bands and the frequency of the cycles at which the at least one moving element is moved. Therefore, for a filter of a predetermined size and bands of equal size, the fewer the number of bands the wider a band would be, hence a scene would be within the filter band for a longer period of time and the cycle may be completed in a longer period of time (e.g. because there is more time to return to the start position), reducing the frequency of the cycles. On the contrary, the higher the number of bands the narrower the width of a band, and as a result a higher frequency of cycles is needed to capture the scene in all bands. Consequently, by reducing the number of bands and increasing the width of the bands it is possible to reduce the frequency of the cycles. This is especially useful in situations in which the speed of apparent motion of a scene increases, for example because the optical system is changed to have an increased focal distance or because the altitude at which the satellite system orbits is lowered to have an increased ground sampling distance (GSD) (since the speed of apparent motion is higher for lower altitudes). Hence, even though the speed of apparent motion increases, there is enough time to run a cycle because the width of the band has also increased (e.g. because there are less number of bands). However, even though on one hand reducing the number of bands would be desirable for systems in which the frequency of the cycles is a limitation (because it would be possible to operate the system at an increased speed of apparent motion without increasing the frequency of the cycles), on the other hand reducing the number of bands may be undesirable since the scene would be captured in fewer bands, providing less information for generating an image or video. So, for example, for a multi-band optical filter of five filter bands where each band is configured to capture exposures at a predetermined color (i.e. wavelength range with a central wavelength in the visible range), given that the number of cycles required to image a segment of a scene through all filter bands for optimizing the spectral resolution with a degree of overlap is six, if the speed of apparent motion increases, the at least one moving element will increase the speed at which it moves and the six cycles will need to be completed in a shorter time. This is a disadvantage for systems having limitations in increasing the frequency of the cycles either because it represents a limitation while it is running or because of how it impacts in its life cycle. Hence, one manner of avoiding losing information by not being able to increase the frequency of the cycles to capture the scene in all filter bands with the desired overlap would be to reduce the number of filter bands. However, if the multi-band optical filter of five filter bands reduces the number of bands by eliminating colors, the spectral resolution would be reduced. One manner of reducing the number of filter bands without reducing the spatial resolution or spectral resolution, without putting an excessive stress on the stabilization system by increasing the frequency of the cycles, is to use a multi-band optical filter with at least one filter array so that instead of five bands the multi-band optical filter may have two filter bands, each of the two bands wider than the width of one of the five bands, wherein the filter array includes the same colors of the the five bands. For example, the multi-band optical filter may include a first filter band and a second filter band, wherein the first filter band may comprise a color filter array, such as the Bayer filter or a filter array including the colors of the five bands, and the second filter band may be a filter band of unfiltered coverage (i.e., a panchromatic band), in order to take advantage of the spatial resolution provided by the panchromatic band and the spectral resolution provided by the color filter array, when an image of a scene is formed based on one or more exposures taken at the first and at the second filter bands. Therefore, it is possible to capture a plurality of exposures so that a segment of the scene is exposed through a different one of the filter bands with successive ones of the plurality of exposures without losing spectral or spatial resolution and without increasing the frequency of the cycles, even though the speed of apparent motion increases, allowing, for example, the satellite to increase its GSD by orbiting al lower altitudes.

In some instances, a continuous variable optical bandpass filter is an example of an optical filter that can be utilized with embodiments described herein, wherein the range of spectral bandwidths having a high transmission varies continuously across the filter. If a continuously variable optical filter is used, it may be used similarly to a multi-band optical filter, wherein the filter can be divided into frequency bands of certain wavelength ranges, such that the number of bands and the bandwidth of each band can be selected. In a continuously variable optical filter, it can be chosen where in the frequency spectrum to sample, and the movement of the stabilization element(s) to capture and to return from the capture can be coordinated with the time interval during which an exposure is to be captured, so that the pixels of the sensor are in the frequency band(s) of interest. Other examples of optical filters may be used with embodiments described herein and are contemplated herein as providing the features and benefits described.

Generally, the filter (such as band, multi-band or continuous variable) and the AID are arranged at fixed relative positions with respect to each other, and move together. However, in certain exemplary embodiments, the filter may be moved with respect to the AID, or the AID may be moved with respect to the filter, or both. For example, in certain exemplary embodiments, when capturing multiple exposures, for example during one cycle or during different cycles, if the scene appears to move at a certain speed, the AID may be moved at the same speed to compensate for the apparent motion so that the image appears to be still. The filter may move together with the AID during a capture, that is, during the exposure time of a capture. However, before a capture starts and/or between captures, it might be advantageous to move the filter a certain distance with respect to the AID, such that a certain frequency band or frequency range of the filter can be selected and the exposure can be captured in the selected frequency band or frequency range.

An active surface 328 of the AID 316 includes a plurality of pixel sensors, such as light-absorbing diodes, arranged in a two-dimensional or a three-dimensional space. The AID may be of various types, such as for example a charge coupled device (CCD), complementary metal oxide semiconductor (CMOS) sensor, or other suitable architecture, and may include more than one CCD, CMOS or other type of sensor, arranged next to each other to act together as one larger AID. In such a case, also more than one optical filter can be used, for example by arranging one optical filter for each sensor of the AID, as explained elsewhere within this Detailed Description. As exemplified in FIG. 3A, the size of the active surface 328 is similar to the size of the filter including all the filter bands 332-338, but in some implementations the size of the filter may be bigger or smaller than the area of the active surface 328. FIG. 3B shows a perspective view of an example partial imaging system for imaging scenes in apparent motion, similar to the one in FIG. 2, in which a filter 330 like the one described in FIG. 3A is included, which may be a continuous variable optical bandpass filter (1), a multi-band optical filter (2), a single band RGGB Bayer optical filter (3), a dual-band optical filter in which a first band has the pattern of filters arranged as an RGBNir optical filter and a second band is a panchromatic band or a neutral density filter (4), or any other suitable distribution of filter bands and type of filters. For example, the multi-band optical filter shown in FIG. 3B (2) may have a band having an M×N filter array, another band having an N×N filter array, a panchromatic filter array and the remaining two filter bands each allowing a different transmitted wavelength range each generally characterized by a central wavelength. As readily apparent to a skilled person in the art, the embodiments comprise any combination of type of filters, number of bands, distribution of filter bands, and/or shape or size of filter patterns in the case of filter arrays.

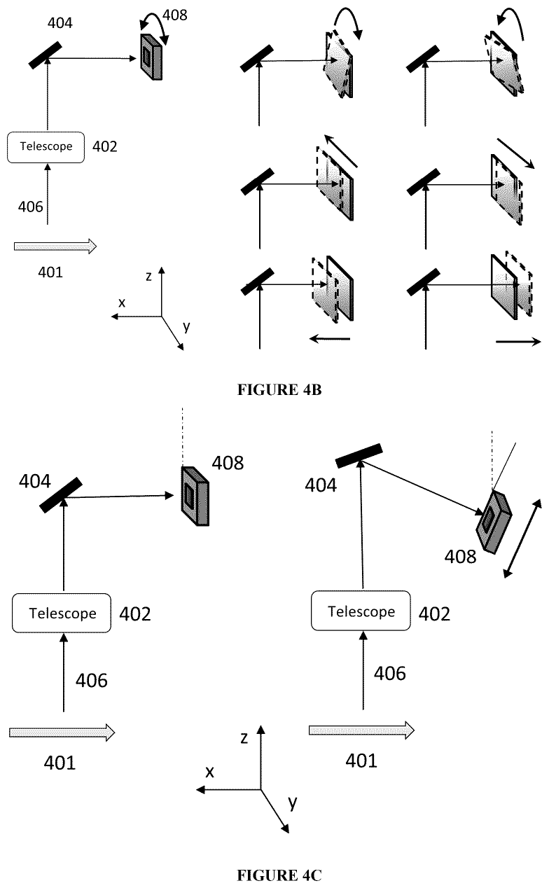

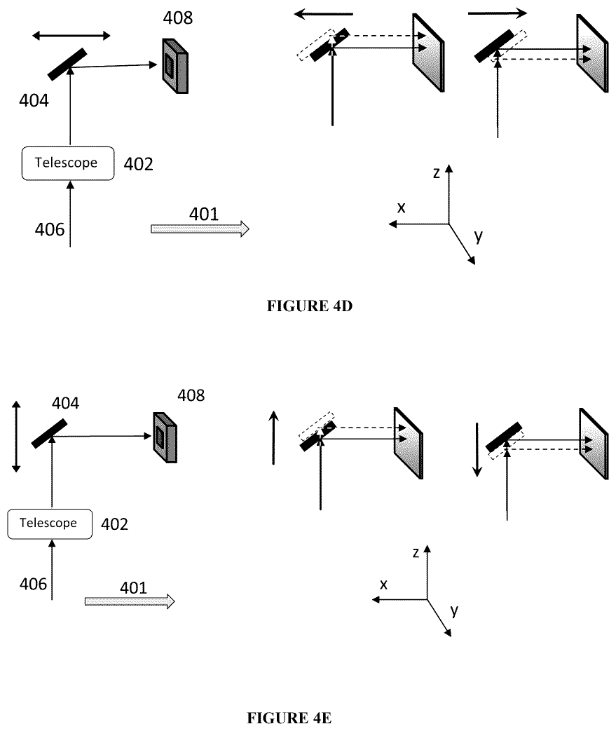

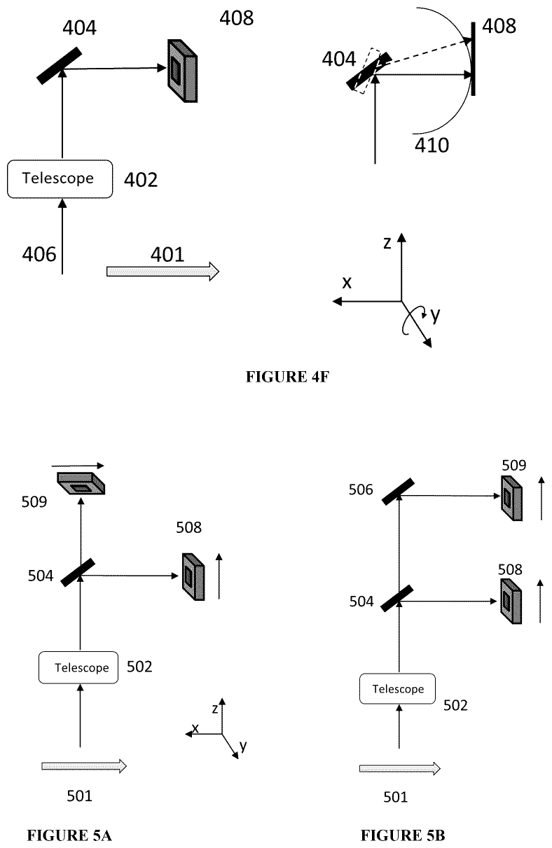

FIG. 4 (4A-4F) schematically illustrates, in part, possible positions and directions of movement of at least one element of an example imaging system for scenes in apparent motion. In the exemplary embodiment of FIG. 4, the apparent motion of the scene in the focal plane of the imaging system follows the direction indicated by arrow 401 (for example because, in an imaging system where the optical system (telescope and its elements) inverts the image, the apparatus or vehicle is moving in the same direction to the direction indicated by the arrow, or in an imaging system where the optical system does not invert the image, the apparatus or vehicle is moving in the opposite direction to the direction indicated by the arrow). In the exemplary embodiment of FIG. 4A, the apparatus or system may comprise a telescope 402, one stabilizing optical element, such as mirror 404, and one AID 408. Some elements which are part of the apparatus or system are not represented in FIG. 2A, as is evident for the skilled person. The mirror 404 may have a certain inclination angle with respect to the direction of the optical axis of the apparatus (z axis in the exemplary embodiment of FIG. 4). The angle within which the mirror may rotate can be determined based on characteristics of the positioning mechanism, such as the run length of the AID 408, and the distance between the mirror 404 and the AID 408. In an exemplary embodiment, for simplicity, the angle set as a starting position may be 45 degrees with respect to the z axis. The mirror may receive the incident light 406 forming the scene passing through the telescope, and may reflect the incident light 406 towards the AID 408. In the exemplary embodiment, the AID 408 may be positioned so as to be able to receive the light reflected on the mirror 404, so that the light hits the surface of the AID from a direction perpendicular to the surface of the AID. In order to perform image stabilization, the stabilization system must compensate for the apparent motion of the scene. In order to do so, with the configuration of the embodiment of FIG. 4, either the mirror 404, the AID 408, or both of them may be configured to be moved by the positioning mechanism under the control of the control module along a respective tracking axis.

The AID 408 may be configured to be moved in different ways. For example, the AID 408 may be configured to be moved along a tracking axis in a direction parallel to the optical axis (up and down, along the z axis, as seen in the representation of FIG. 4A), by moving platform 218 (as seen in FIG. 2) along a tracking rail. By moving the AID in this direction, at the different positions of the AID along the z axis, the rays of light that pass through the telescope 402 and are reflected by the mirror 404 reach the AID at different positions along the z axis, which for the AID is as if the scene being imaged is moved. In a conventional configuration, where there is no mirror and the AID is located in the position of the mirror 404, i.e. oriented perpendicular to the optical axis so as to directly receive the light that passes through the telescope, if the apparent motion of the scene in the focal plane of the imaging system follows the direction indicated by arrow 401, (for example because, in an imaging system where the optical system inverts the image, the apparatus or vehicle is moving in the same direction to the direction indicated by the arrow, or in an imaging system where the optical system does not invert the image, the apparatus or vehicle is moving in the opposite direction to the direction indicated by the arrow) the AID would be moved along the x axis, which would correspond to the tracking axis, in the same direction as the arrow 401 in order to compensate for the movement. Following a similar principle, in the configuration of FIG. 4A, with the presence of mirror 404, the AID 408 will move up along its tracking axis, which in this case is the z axis, in order to compensate for the movement, and the AID 408 will be controlled to capture exposure(s) while moving in said direction, or when stopping while moving in said direction. As seen above, the torque generated by the direction and speed of the movement of the AID 408 will be dependent on the vector product (cross product) of the vector between the center of mass of the apparatus and the position of the AID, and the vector in the direction in which the AID is moving. As the skilled person knows, a property of the vector product is that it is minimum for parallel vectors, and maximum for perpendicular vectors. When trying to reduce the perturbations caused by the movement of the elements of the stabilization system, in certain examples in which the center of mass of the apparatus is located approximately inside the telescope, by having the AID 408 placed in the position represented in FIG. 4A, and moving it along the z axis, the angle formed by the vector between the position of the AID and the center of mass, and the vector of movement in the direction in which the AID moves, will be less than 90 degrees, which will reduce the generated torque.

The AID may in addition or alternatively be moved along a tracking axis following any other direction in the y-z plane, for example to capture multiple exposures during each cycle of a plurality of cycles at different positions along the y and/or z direction, which may be less than a pixel's distance apart or a multiple thereof, to generate an increased resolution image. This can be done by a rotation movement as seen in FIG. 4B, for example placing the AID 408 on a circular plate and rotating the circular plate along a circular rail and additionally moving the AID 216/408 along the tracking rail, in an oblique direction. The AID 408 may in addition or alternatively be rotated about the y axis, as seen in the representation of FIG. 4C, and moved along the tracking rail, following a direction with a certain angle of inclination with respect to the optical axis. This movement may be performed in combination with an equivalent rotation of the mirror 404 in order for the light to reach perpendicularly the active surface of the AID 408. The angle may be varied, and if the center of mass of the apparatus is located in the telescope, the smaller the angle with respect to the optical axes, the smaller the vector product and hence the smaller the net torque generated by the movement of the AID. In addition, if the center of mass of the apparatus is in another place, having the freedom to change the direction in which the AID can be moved allows to adapt to the position of the center of mass to thereby try to reduce the vector product and therefore the net torque generated by the movement of the AID. This configuration allows to move the AID in a direction that can range from being parallel to the optical axis to perpendicular to the optical axes (within the z-y plane, as seen in the representation of FIG. 4C), and based on physical or mechanical constraints, including reasons of space available with respect to other elements of the apparatus, it can be decided which one is more suitable. The AID 408 may alternatively or additionally be moved in a direction perpendicular to the optical axis (left and right, along the x axis as seen in the representation of FIG. 4B). By moving in this direction, at the different positions of the AID along the x axis, the focus position of the AID can be adjusted. Yet in addition, the AID 408, and also or alternatively the mirror 408, may be moved in a curved line within the y-z plane, the x-y plane, the x-z plane, or any other plane.

The mirror 404 may be moved in different ways. The mirror 404 may be moved (by translation) and/or may be rotated. For example, the mirror 404 may be moved along a tracking axis in a direction perpendicular to the optical axis (along the x axis in the representation of FIG. 4D). By moving it along a tracking axis in a direction perpendicular to the optical axis, at the different positions of the mirror, the rays of light that pass through the telescope also hit the mirror at different points on the mirror, which in turn causes the rays to be reflected at lower or higher positions along the z axis and to reach the AID 408 at different positions along the z axis. An additional effect might be a change on the focus of the AID 408 in the x axis direction, because the effect of moving the mirror in this way is for the AID as if the scene being imaged is moved in diagonal, that is, not only moved along the z axis, but is also moving closer and further from the AID 408. In other words, for the AID 408 it is as if the scene being imaged is moved up and down, but also closer and further, so this movement can be also used to adjust the focus of the image. The mirror 404 may, in addition or alternatively, be configured to be moved along a tracking axis in a direction parallel to the optical axis (along the z axis, as seen in the representation of FIG. 4E). By moving in this direction, a similar result may be achieved to that of moving it along the x axis, and a focus position of the AID 408 can also be adjusted, as the path length of the rays will vary.

The mirror 404 may also be rotated about one axis, such as about the y axis (as seen in the representation of FIG. 4F). Also by rotating the mirror, not only the image is moved, but also the focus position is changed. For the AID 408, rotating the mirror 404 as in FIG. 4F will be as if the scene being imaged is moved up and down, but also closer and further, because the scene being imaged will rotate along a circle 410, moving closer and further and up and down along the circle. By rotating the mirror of FIG. 4F about its own longitudinal axis, a similar effect can be obtained. In certain instances, rotating the mirror instead of moving it by translation may have the advantage that it requires moving a smaller mass, and can be done faster. If a curved sensor is present in the AID, for example with a shape similar to circle 410, the effect of rotating the image along a circle caused by rotating the mirror can be reduced or avoided, and the image may be kept in focus.

Therefore, by moving the mirror along the x or z direction, and by rotating the mirror about the y axis and its own longitudinal axis, similar effects can be obtained, and the image changes both position and focus. Taking into account the f-number of the telescope, if it provides a depth of focus, that is, an area around (before and after) the focal plane in which the image is in focus, which is sufficiently deep, the image can be kept in focus even by moving or rotating only the mirror 404. This type of arrangement in which only the mirror is moved or rotated can be useful in situations in which the confocal parameter is not too small (large depth of focus) and the range of movement (translation or rotation) for the stabilization is not large (larger than the depth of focus or a range which maintains the image within the depth of focus). The mirror may in addition or alternatively be moved in any other direction in the x-y plane, to create combined movements. Therefore, the AID 408 and/or the mirror 404 may be moved along their respective tracking axes in straight lines, in curved lines and/or in a rotational movement as seen above. Additionally or alternatively, the mirror 404 may be a deformable mirror which may be used to complement the movement of the AID 408, and/or may be used without being necessary for the positioning mechanism to move the AID 408 and/or the mirror 404 following translational movements but deforms the mirror 404, so that the deformation on the deformable mirror acts as if the mirror is moved following translational movements (e.g. in straight lines, in curved lines, in a rotational movement) or may create combined movements.

In some embodiments, the control module may be configured to control the positioning mechanism to move the mirror as seen above while keeping the AID in a fixed position. Moving the mirror instead of the AID has the advantages of being lighter, having no cables attached, and not dissipating heat, and requires overall less energy consumption. It therefore contributes to the decoupling of the mobile mass from the mass of the AID. However, care should be taken that the movement of the mirror does not set the image out of focus, as seen above. In some embodiments, the control module may be configured to control the positioning mechanism to move the AID as seen above while keeping the mirror in a fixed position. This has the advantage that the AID can be moved in such a way that the focus position of the image will not be changed. In some embodiments, the control module may be configured to control the positioning mechanism to move both the AID and the mirror in a composed movement, where both the AID and the mirror are moved at the same or different distance and/or speed. The distance that the mirror and the AID need to move depends on the direction of the movement. For example, if both the mirror and the AID move along the x axis, they will have to move the same distance, however if the mirror or the AID moves along the xz direction (perpendicular to its surface), the distance the mirror and the AID will have to move will be different. For example, if the mirror 404 is moved along the x axis as represented in FIG. 4D, and the AID 408 is moved in synchronization with the mirror also along the x axis as shown in FIG. 4B, the change in focus introduced by the movement of the mirror can be corrected with the movement of the AID. For another example, if the mirror 404 is moved along the z axis as represented in FIG. 4E, and the AID 408 is moved in synchronization with the mirror, but along the x axis, the change in focus introduced by the movement of the mirror can also be corrected with the movement of the AID.

By moving the AID 408 along a tracking axis in a direction parallel to the optical axis, as seen in FIG. 4A, or by moving the AID along a tracking axis in a direction perpendicular to the optical axis and also moving the mirror 404 along a tracking axis in a direction perpendicular or parallel to the optical axis, or by rotating the mirror, or by deforming the mirror if it is a deformable mirror, or by moving the AID along a tracking axis in any direction with an angle between the direction of the optical axis and the direction perpendicular to the optical axis, in a straight or curved line, as long as the movement or the rotation is done at a speed corresponding to the speed of apparent motion of the scene, and as long as the path length of the rays that reach the AID 408 is kept within the confocal length of the AID (depth of focus), it is possible to make the scene appear to be still, and therefore forward motion of the vehicle can be compensated. This is because the light (the image) that reaches the AID 408 is equivalent to the light (the image) that would reach the AID if the AID was placed so as to move in a direction perpendicular to the optical axis and there was no mirror in between. However, the advantage of the structures of FIG. 4 is that, by moving the AID 408 along a tracking axis in a direction not perpendicular to the optical axis, such as in a direction parallel to the optical axis, or by not moving the AID and moving the mirror 404, or by moving both the AID and the mirror, additional levels of freedom of movement of moving elements can be achieved, and the resulting net torque caused by the composed movement can be controlled so that it can optimize other aspects of the apparatus, such as improving thermal dissipation, making a more efficient use of the available space, allowing to introduce or increase the size of the elements of the stabilization system to improve quality and/or quantity of captured images, reducing the vibrations caused during launch or during operation, reducing the torque generated by the movement of the AID, or the like. For example, if the resulting composed movement (net torque) follows a direction not parallel to the apparent motion, the introduction of perturbations that affect the attitude of the apparatus or system may be reduced or eliminated. At the same time, if the movement is performed at a speed that is the same as that of the apparent motion of the scene, for a sufficient amount of exposure time, it results in a suitable dynamic range image that is free from or has reduced motion blur. Although the examples of FIG. 4 show movement of the AID and/or the mirror along certain axes, it should be understood that other movements along other directions can be also performed, for example to generate images with increased resolution.

The actuators controlled by the positioning mechanism may include linear actuators and rotary actuators. Linear actuators for tracking may include piezoelectric motors, stepper motors, ultrasonic piezoelectric motors, or other suitable actuator or device. The rotary actuators may be piezoelectric motors, stepper motors, or other suitable actuators. Each mirror 404 may be displaced by a linear motor, by two or more linear motors, or by at least one rotary motor, and may be rotated by at least one rotary motor. Each AID 408 may be displaced/rotated by a linear motor, by two or more linear motors, or by at least one rotary motor.

The mirror(s) or the AID(s) may alternatively be located on an n-axis positioning mechanism such as a tetrapod, an hexapod, or an octopod, which provide high precision movements, instead of being moved by linear and/or rotary actuators. This has the advantage of providing additional degrees of freedom for the movements that can be performed. Alternatively, the positioning mechanism may include multiple single-axis positioning mechanisms arranged in sliding platforms and wedges for composing the movement. In some instances, linear actuators may control the sliding platforms.

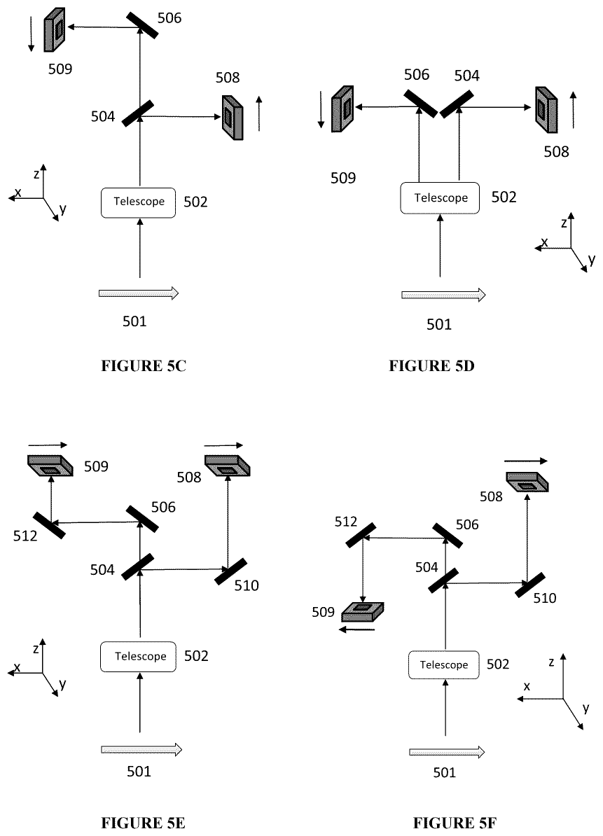

FIG. 5 (5A-5G) schematically shows, in part, different arrangements of an example imaging system for scenes in apparent motion. In the exemplary embodiment of FIG. 5, the apparatus or system may comprise more than one mirror and/or more than one AID. For example, FIG. 5A shows an exemplary embodiment comprising two AIDs 508 and 509, wherein AID 508 is arranged parallel to the optical axis and AID 509 is arranged perpendicular to the optical axis, and one mirror 504. The mirror 504 may be a mirror that totally or almost totally reflects the incident light, or it may be a dichroic mirror or semi mirror, that reflects light of certain wavelength(s) while letting light of other wavelength(s) pass. Such a dichroic mirror may be designed to reflect and let different wavelengths pass depending on the application. For example, the dichroic mirror according to embodiments of the present disclosure may reflect light wavelengths below a certain wavelength threshold, and let light wavelengths equal to or above the certain wavelength pass. If the dichroic mirror is used, one of the AIDs may be determined to be switched off and only the other AID may be switched on. The AIDs may have certain different characteristics, and it may be more useful to use one or the other depending on the application or depending on other aspects. For example, each AID may be configured to detect light in different wavelength ranges, for example based on the wavelength threshold, and it may be useful to use one of the AIDs and not the other one when for example only certain wavelengths are desired to be received. If the dichroic mirror is used, each of the AIDs may also be configured to detect different wavelength ranges, wherein for example AID 508 is configured to detect light below (or equal to) the wavelength threshold of around 700 nm or 600 nm, or any other suitable wavelength, and AID 509 is configured to detect light above (or equal to) the wavelength threshold. By having this arrangement, the image stabilization may be achieved by moving AID 508 along a tracking axis corresponding to the z axis and moving AID 509 along a tracking axis corresponding to the x axis to compensate for the apparent motion of the scene. AIDs 508 and 509 may move in synchronization with each other, but this is not necessary. For example, they may move in synchronization so as to capture images simultaneously, or so as to capture images in a complementary fashion, so that while one of the AIDs is returning to the starting position (after having moved forward from the start position along the tracking axis, and having reached an end position) the other AID can be capturing images. In this example, the tracking axis of AID 508 may be parallel to the optical axis, but AID 508 may also be rotated about the y axis and be moved along a tracking axis following a direction with a certain angle with respect to the optical axis, or may be rotated about the x axis and move along a tracking axis in diagonal, as seen elsewhere within this Detailed Description, such as in relation with FIG. 4. The tracking axis of AID 509 may be perpendicular to the optical axis, however AID 509 may also be rotated about the x axis and move along a tracking axis following a direction with a certain angle with respect to the optical axis, or may be rotated about the z axis and move along a tracking axis in diagonal. When trying to reduce the perturbations caused by the movement of the elements of the stabilization system, in exemplary embodiments in which the center of mass is located in the telescope, if AID 509 is moved along a tracking axis in a direction perpendicular to the optical axis and AID 508 is moved along a tracking axis in a direction parallel to the optical axis, the net torque generated is less than the torque that would be generated if only AID 509 was moved, because the torque also depends on the distance between the moving elements. In this configuration of FIG. 5A, when AID 508 moves parallel to the optical axis and AID 509 moves perpendicularly to the optical axis, if the apparent motion of the scene in the focal plane of the imaging system follows the direction indicated by arrow 501 (for example because, in an imaging system where the optical system inverts the image, the apparatus or vehicle is moving in the same direction to the direction indicated by the arrow, or in an imaging system where the optical system does not invert the image, the apparatus or vehicle is moving in the opposite direction to the direction indicated by the arrow), in order to compensate for the movement of the scene (which may be caused by the movement of the apparatus), AID 508 could move up along the z axis, and AID 509 could move in the same direction as that indicated by arrow 501. An advantage of this configuration is that, by having two AIDs, more images can be captured than using only one AID. Another advantage is that, because the frequency bands can be divided among the two AIDs (when a multi-band filter is used), the stabilization can be performed slower, because there are lees bands to be covered in the one or more cycles in which the moving element(s) move and capture exposures, thereby causing less shake (sway, wobble). The mirror 504 may also be moved along a tracking axis corresponding to the z-axis, along the x-axis and by rotation as described elsewhere within this Detailed Description, such as in relation with FIG. 4. In satellite embodiments, AIDs 508 and 509 may be placed after a telescope, and mirror 504 allowing the transmission of a range of wavelength and the reflection of another range of wavelengths, may be placed between the telescope and the AIDs, such that AID 508 is placed at a focal plane of the telescope parallel to the optical axis and AID 509 is placed at a focal plane of the telescope perpendicular to the optical axis.

In the exemplary embodiment of FIG. 5B, two mirrors and two AIDs are used. In this configuration, a first mirror 504 may be a dichroic mirror allowing to pass certain parts of light while reflecting other parts, such as certain wavelengths, such as allowing light below (or equal to) a wavelength threshold (for example of around 700 nm) to be reflected towards a first AID 508, which is configured to receive light in said wavelength range, and letting light above the wavelength threshold pass and be directed towards a second mirror 506. The second mirror 506 may be a mirror that does not let (most of the) light pass through, and (most of) the light that reaches the second mirror 506 may be reflected towards a second AID 509, which is configured to receive light above (or equal to) the wavelength threshold. AIDs 508 and 509 may be moved along respective tracking axes parallel to the optical axis. In such cases, image stabilization in the exemplary embodiment of FIG. 5B can be achieved by moving the first AID 508 and second AID 509 along tracking axes corresponding to the z axis. In this configuration, if the apparent motion of the scene in the focal plane of the imaging system follows the direction indicated by arrow 501 (for example because, in an imaging system where the optical system inverts the image, the apparatus or vehicle is moving in the same direction to the direction indicated by the arrow, or in an imaging system where the optical system does not invert the image, the apparatus or vehicle is moving in the opposite direction to the direction indicated by the arrow), in order to compensate for the apparent movement of the scene, AID 508 and AID 509 could move up along the z axis. This configuration may be advantageous, for example in exemplary embodiments in which the center of mass is located in the telescope. In such case, if the vector product between the vector between the center of mass and the position of each AID, and the vector in which each AID is moving, has as a result a vector with a direction deviating from the optical axis an angle lower than a threshold angle, the composed movement may not cause any net torque that may affect the attitude of the apparatus. Mirrors 504 and/or 506 may also be moved along respective tracking axes following directions along the x axis or the z axis, or by rotation about the y axis or their longitudinal axis. AIDs 508 and 509 may be moving along tracking axes parallel to the optical axis, but they may also be rotated about the y axis and be moved along tracking axes along directions with a certain angle with respect to the optical axis, or may be rotated about the x axis and moved in diagonal, as seen elsewhere within this Detailed Description, such as in relation with FIG. 4.

Another advantage provided by this configuration is that both AIDs can be placed in the same plane, so for example they can both be located in the same printed circuit board (PCB), which provides advantages to the electronic and mechanical design.

In the exemplary embodiment of FIG. 5C, also two mirrors and two AIDs are used. The difference with respect to the arrangement of FIG. 5B is that mirror 506 in FIG. 5C is rotated 90 degrees with respect to mirror 506 of FIG. 5B. As a result, AID 509 is located opposite to AID 509 of FIG. 5B with respect to mirror 506. AID 508 and AID 509 may also be moved along respective tracking axes corresponding to the z axis. In this configuration, if the apparent motion of the scene in the focal plane of the imaging system follows the direction of arrow 501 (for example because, in an imaging system where the optical system inverts the image, the apparatus or vehicle is moving in the same direction to the direction indicated by the arrow, or in an imaging system where the optical system does not invert the image, the apparatus or vehicle is moving in the opposite direction to the direction indicated by the arrow), in order to compensate for the apparent motion of the scene, AID 508 could move up along the z axis, while AID 509 could move down along the z axis. This configuration may be advantageous, for example in exemplary embodiments in which the center of mass is located in the telescope. In such cases, and depending on the vector product as described above, the composed movement may also follow a direction deviating from the optical axis (the direction that passes through the center of mass of the apparatus) an angle lower than a threshold angle, thereby not causing any net torque that may affect the attitude of the apparatus. In this arrangement, in addition, symmetry is achieved in the composed movement, which leads to a better distribution of the torques. Mirrors 504 and/or 506 may also be moved along respective tracking axes corresponding to the x or z axes or by rotation about the y axis.

In the exemplary embodiments of FIGS. 5A-5C, both AIDs may be synchronized to capture images at the same time, or at complementary or alternating times, or may capture images at different times, in one or more cycles. If the images are captured at different times, post-processing can be applied to reconstruct the images. In addition, multiple exposures may be captured during a cycle so that each intra-cycle exposure may have a different exposure time in order to generate a high dynamic range image, and in some implementations, the exposure times for the intra-cycle exposures may be different for each AIDs.

In the exemplary embodiment of FIG. 5D, also two mirrors and two AIDs are used. The difference with respect to the arrangement of FIG. 5C is that mirrors 504 and 506 are both intercepting the light that passes through the telescope, in such a way that the scene to be imaged is divided and part of the light, such as half of it, hits mirror 504 while the remaining part hits mirror 506. As a result, none of AIDs 508 and 509 receives the whole scene at each moment in time. However, if the apparent motion of the scene in the focal plane of the imaging system follows the direction of arrow 501 (along the x axis), and both AIDs 508 and 509 are moved along respective tracking axes in synchrony with the same speed, such that AID 508 moves up along the z axis and AID 509 moves down along the z axis, as the apparatus moves, the scene is eventually captured completely by both AIDs. Multiple partially overlapping exposures may be captured by causing the AIDs 508 and 509 to cycle through multiple runs along the tracking axis, so that the exposures in each successive cycle have a determined amount of overlap, which enables the exposures to be stitched together to form an image of arbitrary length. Each segment of the image may be exposed through both AIDs during successive cycles while the apparatus moves. By operating in this manner, the net torque is zero.

In the exemplary embodiment of FIG. 5E, also two mirrors and two AIDs are used. The difference with respect to the arrangement of FIG. 5C is that additional mirrors 510 and 512 are placed in FIG. 5E in the places where AIDs 508 and 509 are located in FIG. 5C. This in turn allows the AIDs to move in a direction along the x axis. If the apparent motion of the scene in the focal plane of the imaging system follows the direction indicated by arrow 501, AID 508 and AID 509 both move along tracking axes in the direction indicated by arrow 501 to compensate for the apparent movement of the scene. However, if both AIDs are moved in opposite directions and in synchrony (moving so as to get closer to and further from each other), the torques they cause by each individual movement will be compensated when operating together, and the result will also not cause net torques that will affect the attitude of the vehicle or apparatus. In this case, in order to obtain image stabilization, both AIDs may not capture images simultaneously, but may capture images in an alternating fashion, in turns. For example, if the apparent motion of the scene in the focal plane of the imaging system follows the direction indicated by arrow 501, in order to compensate for the movement, the images are to be captured when the AIDs are moving in the direction of apparent motion, so as to achieve the still image. However, because the AIDs will be synchronized to move in opposite directions, they will not follow the direction of apparent motion at the same time but in alternative moments, and therefore the images will not be captured at the same time by both AIDs, but in alternating moments. Another advantage provided by this configuration is that both AIDs can be placed in the same plane, so for example they can both be located in the same printed circuit board (PCB), which provides advantages to the electronic and mechanical design.

In the exemplary embodiment of FIG. 5F, also four mirrors and two AIDs are used, similarly to FIG. 5E. The difference with respect to the arrangement of FIG. 5E is that mirror 512 is rotated 90 degrees with respect to mirror 512 of FIG. 5E, and AID 509 is located opposite to AID 509 of FIG. 5E. With this configuration, if the apparent motion of the scene in the focal plane of the imaging system follows the direction of arrow 501 (along the x axis), in order to compensate for the apparent movement of the scene, AID 508 will move along a tracking axis corresponding to the x axis, in the same direction as the direction indicated by arrow 501, and AID 509 will move along a tracking axis corresponding to the x axis, but in a direction opposite to the direction indicated by arrow 501. With this configuration, both AIDs move with synchronization so as to neutralize or reduce potential disturbances caused by their movement perpendicular to the optical axis, but they can capture images simultaneously, as they need to be moving, or have moved, in opposite directions, when the images are captured, to compensate for the movement of the apparatus.

In the exemplary embodiment of FIG. 5G, two mirrors and one AID are used. The configuration in FIG. 5G is similar to the part of the configuration of FIG. 5F corresponding to mirror 509. Mirror 504 reflects, towards mirror 510, light that has passed through the telescope 502. Mirror 510, in turn, reflects light towards AID 508. A difference with respect to the previous configurations of FIG. 5 is that, with this configuration, not the AID but the mirrors are moved. If the apparent motion of the scene in the focal plane of the imaging system follows the direction of arrow 501 (along the x axis), in order to compensate for the apparent movement of the scene, mirrors 504 and 510 will move along respective tracking axes corresponding to the x axis, simultaneously in the same direction as arrow 501. In this way, the apparent motion of the scene may be compensated. An additional advantage of this configuration is that it allows to improve the mechanical or electronic structure of the apparatus, because AID 508 may be placed so as to be on top of the telescope and in contact with it, which may simplify the mechanical design because the AID, which may dissipate a considerable amount of heat, can be put in contact with an important structure in the apparatus, such as the telescope. Another advantage of this configuration is that, by allowing the AID to be placed on the telescope, the size of the AID can be increased, or multiple AIDs may be placed to form together a large focal plane.

In the exemplary embodiments with more than one AID or with more than one mirror, the movement of the elements can be performed in synchrony as seen above, or the elements may be moved independently from one another, each element having its own control loop. Additionally or alternatively, some or all of the mirrors may be deformable mirrors which may be used as described for the examples of FIG. 4.

In order to determine the speed of apparent motion, so as to determine the speed of movement of the AID(s) and/or the mirror(s) and/or other stabilizing optical elements, the control module may use a priori information and/or sensor information according to some exemplary embodiments. For example, the speed of apparent motion may be determined from sensor information (for example from movement sensors or other sensors) and orbit information, for example based at least in part on orbit characteristics of the apparatus and on characteristics of the optical system. The orbit characteristics may comprise information associated with at least one of an altitude, a velocity, a shape, a position and an orbital period of the apparatus, or another orbit-related information. The characteristics of the optical system may comprise at least one of an aperture diameter and a focal length of the telescope. For example, the orbit of a LEO satellite may be 700 km high in a typical situation. At this altitude, the orbital period is 98 minutes and 37 seconds and the projected velocity on the ground is 6764 m/s. A telescope may be a Cassegrain with an aperture diameter of 30 cm and a focal length of 2.5 m. Thus, each meter on the ground will be projected as a 3.6 μm image on the focal plane, and will be moving at 24.2 mm/s. The linear actuator for tracking is able to move at least at this velocity in order to compensate for the movement of the image. Based on this information, the speed of movement of the moving elements (AID(s) and/or mirror(s) and/or other stabilizing optical elements) can be obtained. The maximum speed of the linear actuator for tracking may be several times higher in order to reduce the time it takes to return the linear actuator for tracking to the start position.

According to some embodiments, the control module may alternatively or additionally use image analysis of the captured images in order to determine the speed of apparent motion, such as image flow analysis, optical flow analysis, phase correlation analysis, or image correlation analysis. Operations based on image displacement from successive images can be used. In some implementations, the operations may include determining along-track (such as vertical) and/or across-track (such as horizontal) gray projections that can be used to find the displacement between two images.

Displacements between successive images may be determined using any type of image analysis, such as using gray projections, image flow analysis, image correlation operations, or the like. Correlation could be done with the whole image, portions of the images, or gray projections. Correlation could be done using a correlation algorithm to measure the displacement of features contained within the image. Some embodiments of the present disclosure correlate using gray projections, which may reduce the computational resources used to perform the function. In some embodiments, once the system is running, or based on having used some initial estimation of direction of apparent motion (e.g., from the known attitude of a aircraft or spacecraft), the system further reduces the correlation to a vicinity of the estimated displacement (instead of evaluating the full range of possible displacements). This further reduces the processing time. In the above description, “attitude” is the direction in which the imaging system is headed, defined for example by three angles with respect to some reference.

In order to determine the run length for each AID and/or each stabilizing optical element, the tracking speed and the time required for the movement are taken into account. The tracking speed is usually the same for all moving elements because it refers to the speed required to compensate for the speed of apparent motion of the scene. The time required for the movement may vary, because for example AIDs (508 and 509) may have different characteristics, such as different sizes, sensitive to different wavelengths, or with filters with different band sizes, and therefore the run length may be different for different AIDs. Consequently, the run length for each stabilizing optical element will depend on the run length of the AID towards which said stabilizing optical element directs the light. The rotation angle of each stabilizing optical element will also depend on the run length of the AID towards which said stabilizing optical element directs the light, and on the distance between the stabilizing optical element and the AID. While the tracking speed required to move the AIDs and/or the stabilizing optical elements from a start position to an end position within a cycle (forward movement) is usually the same for all moving elements to compensate for the speed of apparent motion of the scene, the speeds required to move the moving elements to return from the end position to the start position within the cycle (backward movement) may vary, depending on the structural characteristics of the moving elements.

Other alternative configurations of exemplary embodiments of the present disclosure include using at least one Risley prism. When using a Risley prism, rotating one wedge in relation to the other wedge conforming the Risley prism will change the direction of the beam. When the wedges angle in the same direction, the angle of the refracted beam becomes greater. When the wedges are rotated to angle in opposite directions, they cancel each other out, and the beam is allowed to pass straight through. This may allow to steer the beam giving additional degrees of freedom to the design. Other alternative configurations include the use of parallel mirrors that move together, that may be similar to the configuration shown in FIG. 5B but moving the mirrors 504 and 506 instead of or in combination with moving the AIDs 508 and 509. Other alternative configurations include the use of retroreflectors, corresponding to a corner with three mirrors. A disadvantage of this implementation is the cost and weight, however it has the advantage that it also provides additional degrees of freedom in the design of the system. Yet another alternative configuration includes using a harmonic oscillator in one single axis, instead of including linear motors with controllers. In this implementation, instead of controlling to move the linear motors (such as piezoelectric motors) by providing a back and forth profile, it only requires to provide the harmonic frequency as control information, and by injecting enough energy to the harmonic oscillator to oscillate in its harmonic frequency, no additional motors are needed. This simplifies the control information required, and improves accuracy as the oscillation frequency will not change. This configuration may also allow to achieve faster speeds of movement than using linear actuators, and may reduce friction. Yet another alternative configuration includes using an optical system that sets the images out of focus, rotating at least one mirror, and having the optical system set the images in focus again.

### Example Operations

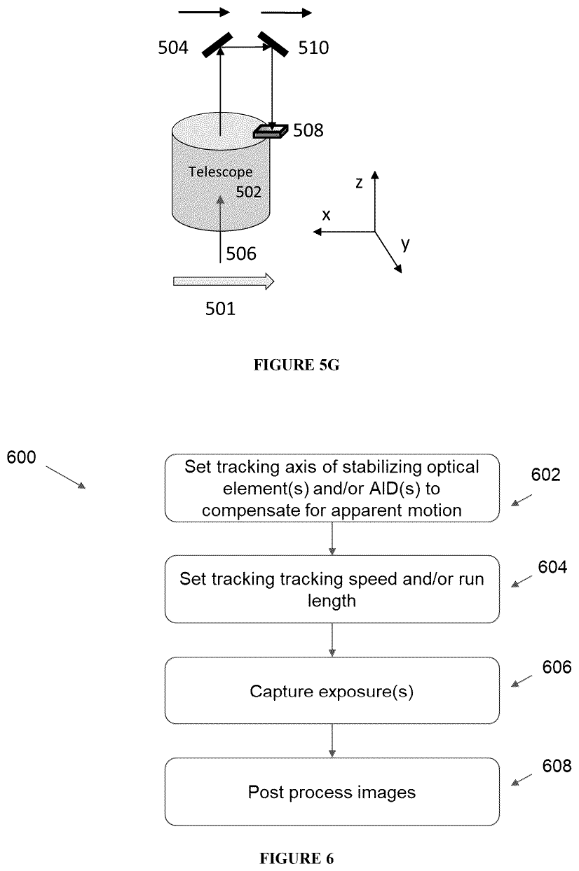

FIGS. 6, 7 and 9 depict flow graphs that show example processes in accordance with various embodiments. The operations of these processes are illustrated in individual blocks and summarized with reference to those blocks. These processes are illustrated as logical flow graphs, each operation of which may represent a set of operations that can be implemented in hardware, software, or a combination thereof. In the context of software, the operations represent computer-executable instructions stored on one or more computer storage media that, when executed by one or more processors, enable the one or more processors to perform the recited operations. Generally, computer-executable instructions include routines, programs, objects, modules, components, data structures, and the like that perform particular functions or implement particular abstract data types. In the context of hardware, the operations may be carried out in an integrated circuit, such as in an application specific integrated circuit (ASIC), a programmable logic device, such as a field programmable gate array (FPGA), graphics processing unit (GPU), tensor processing unit (TPU), digital signal processors (DSPs), or central processing units (CPUs). Other examples of hardware may be used with the embodiments described herein and are contemplated herein as providing the features and benefits described. The order in which the operations are described is not intended to be construed as a limitation, and any number of the described operations can be combined in any order, separated into sub-operations, and/or performed in parallel to implement the process. Processes according to various embodiments of the present disclosure may include only some or all of the operations depicted in the logical flow graph. Moreover, the operations may be carried out by a single system, such as onboard a spacecraft or ground-based station, or may be shared between multiple systems located onboard the spacecraft or ground-based systems.

FIG. 6 is a flow diagram showing an example overview process 600 for image capture using an imaging system or apparatus for scenes in apparent motion. At 602, a control module of an imaging system directs a positioning mechanism to set respective tracking axes of at least one AID and/or at least one stabilizing optical element parallel to at least one direction along which the at least one AID and/or at least one stabilizing optical element can move to compensate for an apparent motion of a scene being imaged. The at least one direction may be determined in different ways, and may have resulting configurations similar to those depicted above in FIGS. 4 and 5. Step 602 may be omitted in embodiments in which the tracking axis/axes is/are already previously set, for example during manufacturing, along a certain direction that is determined as explained elsewhere within this Detailed Description. At 604, the control module directs the positioning mechanism to set a tracking speed and/or run length of the at least one AID and/or at least one stabilizing optical element based on at least one of image analysis or on a priori information and characteristics related to the image system, including orbit characteristics and/or optics characteristics. At 606, the control module directs the imaging device to capture at least one exposure, such as by directing the positioning mechanism to move at least one of the at least one AID and the at least one stabilizing optical element along the tracking axis in one or more cycles and to direct the AID to capture at least one exposure during each of the one or more cycles to generate at least one exposure, such as a plurality of exposures, such as a plurality of partially overlapping exposures. At 608, the imaging module processes the exposures to generate an image, such as by stitching together the plurality of overlapping exposures to form an image of the scene. The processing may include utilizing multiple exposures from each cycle at different exposure times to generate high dynamic range images. The processing may include higher resolution images from multiple exposures per cycle each taken with a displacement that is not an integer multiple of a single pixel, such as sub-pixel across-track (such as horizontal) displacements and/or sub-pixel along-track (such as vertical) displacements as described elsewhere within this Detailed Description. The processing may include color images from multiple exposures per cycle taken with displacements based on the filter arrangement of the filter mosaics. Images from consecutive and partially overlapping images are stitched together. A sufficient number of exposures can be obtained to generate an image of any length. A stitching algorithm is utilized in some embodiments to generate a final image (or video frame) from the multiple partially overlapping exposures. Multiple exposures may be captured during each cycle. Each intra-cycle exposure may have a different exposure time, in order to provide advantageous or optimal exposure times for each filter band, in order to generate a high dynamic range image.

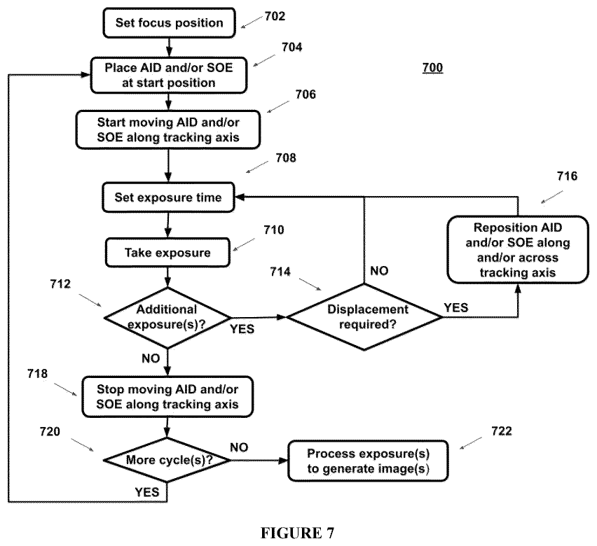

FIG. 7 is a flow diagram showing an example process 700 for imaging a scene that is in apparent motion according to embodiments. At 702, the control module of the imaging system controls the positioning mechanism to set the position and/or distance from the optical system (telescope and its elements) to the at least one AID in order to focus the image. In some instances, the control module may operate a linear actuator to move the at least one AID and/or the at least one stabilizing optical element, to set the focus length of the imaging device. For example, in the exemplary embodiments of FIGS. 4 and 5, the movement or rotation of the stabilizing optical element(s) (mirror(s)) may change the path length of the rays (beam), and the movement of the AID(s) along any direction other than the z-direction (for the AIDs oriented parallel to the z axis) or along any direction other than the x-direction (for the AIDs oriented perpendicular to the z axis), may also change the path length. In certain embodiments, if the focus position is set beforehand, for example during manufacturing, this step may be omitted.

At 704, the control module directs the positioning mechanism to place the AID and/or the stabilizing optical element (SOE) at the start position. The AID and/or SOE can begin a cycle once the AID and/or SOE is at the start position. Hence, if a cycle has ended and the AID and/or SOE has reached an end position or if the cycle has been interrupted before reaching the end position, the control module directs the positioning mechanism to move the AID and/or SOE from any position between the start and end position (intermediate position) to the start position or backward from the end position to the start position. At 706, the control module directs the positioning mechanism to move the AID and/or SOE along the tracking axis at the tracking speed that compensates for the speed of apparent motion and along a run length, such as by controlling a linear actuator for tracking. At least the tracking speed and the run length are determined before starting the cycle, as explained elsewhere within the Detailed Description.

At 708, the control module sets an exposure time for the exposure taken within the cycle (intra-cycle exposure). The control module may set the same exposure time for each exposure of multiple exposures within a cycle, may set a different exposure time for each exposure of multiple exposures within a cycle or may set a different exposure time for a subgroup of exposures of multiple exposures within a cycle. For example, five exposures taken in a single cycle may all have the same exposure time. Alternatively, each exposure of the five exposures within a cycle may have a different exposure time so that there are five exposure times, one for each exposure. Optionally, for example two exposures from the five exposures within a cycle may have a first exposure time and the remaining exposures may have a second exposure time different from the first exposure time. It should be understood that these are possible examples, however other possibilities and combinations are also included herein. Taking images with different exposure times allows the system to take into account the different ones of the optical filter bands of the filter, such as multi-band optical filter, permitting differing amounts of light to pass through. It also allows the system to perform high dynamic range imaging (e.g., combining several exposures taken with different parameters into a single image). For example, if the scene being imaged is over-illuminated in one portion and under-illuminated in another portion, then the imaging system may combine two or more exposures taken at different exposure times to generate an image that appears to be properly illuminated, or more evenly illuminated, at all portions. In addition or alternatively, the control module may set one or more exposure times for one or more cycles, such that if for example one exposure time is selected for each cycle, different cycles may have different exposure times. For example, the control module may set a first exposure time for one or more exposures of a first cycle and a second exposure time for one or more exposures of a second cycle, such that if the first exposure time is different from the second exposure time, either longer or shorter, different cycles may have different exposure times. Alternatively, different cycles may have the same exposure time. Hence, the control module may select the same or a different exposure time for each cycle, and/or may select the same or different exposure time for each exposure within a cycle (intra-cycle exposure).

Additionally, at 708, the control module may check or determine whether the exposure time calculated at 708 or otherwise received, is less than a time of the run length of the AID and/or less than a time of the run length of the SOE, depending on whether the AID, the SOE, or both, are configured to be moved along their respective tracking axes. The time of the run length is the cycle time minus the time it takes for the positioning mechanism to return the AID, or the SOE to the start position. The cycle time is the amount of time that it takes for the positioning mechanism to move an AID or a SOE from a start position to an end position along a run length, and then return the AID or the SOE to the start position. Therefore, the cycle time depends on the tracking speed, the run length, and the speed that the positioning mechanism is configured to return the AID or the SOE to the start position. At least the tracking speed and the run length are determined previously. Generally, the tracking speed is set or determined so as to compensate for the speed of apparent motion and the speed for returning the AID or the SOE to the start position is set or determined to be higher than the tracking speed. Where the exposure time is not less than the time of the run length, the control module at 708 sets the exposure time to be less than or equal to the cycle time minus the time it takes for the positioning mechanism to return the AID and/or the SOE to the start position. Where the exposure time is less than the remaining run length time, the control module at 708 sets an exposure time for an exposure within the cycle. Having the possibility of setting an exposure time for each exposure within a cycle allows the control module to select the same or a different exposure time for each exposure within a cycle, provided that the selected exposure is less than the remaining run length time.

At 710, the control module directs the AID to take an exposure for an exposure time determined at 708 while the AID and/or SOE continues to move along their respective tracking axes at the tracking speed that compensates for the speed of apparent motion. The resulting image data from each filter band is saved. At 712 the control module determines whether the cycle time permits, and/or whether the operational parameters for the imaging job specify additional exposures to be taken during the current cycle.

Where permitted and specified (the “YES” arrow), at 714 the control module determines whether a displacement is required. Where the additional exposures are to be used to generate a high resolution image or colored image using filter mosaics (the “YES” arrow), at 716, the control module directs the positioning mechanism to position the AID and/or the SOE to a new position (i.e. reposition) such that the new position is offset across or along their respective tracking axes a predetermined distance from an initial position. For example, where the additional exposures are for generating a high-resolution image based on displacements along and/or across the tracking axis between successive images that are not an integer multiple of a single pixel, the control module directs the positioning mechanism to position the AID and/or the SOE to be across-track (such as horizontally) or along-track (such as vertically) offset. Such across-track or along-track displacements may be sub-pixel displacements, as well as displacements that are larger than single pixels, as long as such displacements are not exactly a multiple integer of a single pixel, such as a displacement of 7.5 pixels or other non-integer displacement. Across-track offset positions may be obtained by moving the AID and/or the SOE along a transverse axis that is perpendicular to their respective tracking axis by a distance, such as less than the distance between two adjacent or neighboring pixels of the AID or some other non-integer multiple of the distance between two pixels. Along-track offset positions may be obtained by causing the AID and/or the SOE to begin a successive exposure at a position that is offset by a sub-pixel distance or other non-integer length between two neighboring pixels from the initial position of a previous exposure along the tracking axis. Either one or both of across-track displaced exposures and along-track displaced exposures (or exposures that are both across-track and along-track displaced) relative to an initial exposure may be obtained in order to provide relatively higher resolution images.

In addition or alternatively, where the additional exposures are for generating color images using filter mosaics based on displacements along and/or across the tracking axis between successive images, at 716, the control module directs the positioning mechanism to position the AID and/or the SOE offset a distance across or along their respective tracking axes from an initial position to a final position, such that the offset distance is determined based on the filter arrangement over the pixel sensors, which may be, for example, a distance of a pixel, where there is a correspondence of one pixel for each filter of the filter mosaic, or a multiple of a pixel. Similarly, where the additional exposures are for generating HDR images using filter mosaics having different neutral density filters suitable, as explained elsewhere within the Detailed Description, based on displacements along and/or across the tracking axis between successive images.

At 714, where a displacement is not required (the “NO” arrow), or after repositioning the AID and/or SOE at 716, the control module sets an exposure time at 708, for the exposure to be taken at 710, as explained above. At 712, where additional exposures are not specified, or where additional exposures are not permitted by the remaining time during the current cycle (the “NO” arrow), at 718 the control module directs the positioning mechanism to stop moving the AID and/or SOE along their tracking axis. At 720, the control module of the imaging system determines whether there are additional cycles remaining in the current imaging job. The number of cycles is determined based on various factors, including the number of bands in the multi-band optical filter, the desired size of the image, and the amount of overlap specified between successive exposure cycles. Where more cycles are to be performed (the “YES” arrow), the control module directs the positioning mechanism to return the AID and/or the SOE to the start position in order to place the AID and/or SOE at the start position at 704. The next cycle is performed, with one or more additional exposures captured during each subsequent cycle. At 720, if the control module determines that all cycles are completed (the “NO” arrow), at 722, an imaging module of the imaging system processes one or more exposures to generate an image or video frame. To obtain HDR images, the imaging module applies a tone mapping algorithm to exposures, such as exposures taken during the same cycle with different exposure times or exposures taken with different intensities using a filter mosaic of neutral density filters as explained elsewhere within the Detailed Description. To generate a high-resolution image, the imaging module applies a resolution enhancement algorithm to exposures taken during the same cycle with along-track and/or across-track displacements from one another of non-integer multiples of the distance between two pixels. Appropriate algorithms and techniques are used to generate color images or HDR images using the exposures taken at positions determined based on the arrangement of the filters over the pixel sensors, when filter mosaics are used. Where more than one cycle is utilized, images from consecutive cycles are stitched together to obtain images with arbitrary length. Since all bands of the multi-band optical filter are used to image the same scene, but vertically displaced from one another (in the direction of apparent motion), the stitching mechanism is used in some embodiments to align the pictures from each band to obtain a multi-spectral image.

A suitable stitching algorithm locates matching features in each image (from different cycles), determines the displacement, rotation, projection, elevation model application, of those features between successive images, applies the displacement and rotation to the full image, and blends both images where they overlap. In embodiments of the present disclosure, the displacement is known a priori, and is based on the length of the bands of the multi-band optical filter minus the desired overlap. Also, no rotation is expected due to having previously aligned the tracking direction of the positioning mechanism with the direction of apparent motion. Some embodiments of the present disclosure may be based on an assumption that rotation is zero, and assume a constant overlap, which simplifies the computational complexity of the stitching algorithm, which may reduce the power consumption and computational requirements of the devices to be used to perform the stitching algorithm. Also, because the tracking direction and/or tracking speed of the linear actuator for tracking are set to compensate for the apparent motion of the scene to be imaged, no or reduced post-processing is used in some embodiments to eliminate blur, further reducing the computational complexity and power consumed during processing, (although such post-processing to reduce blur may be used without departing from the scope of embodiments).

For panchromatic video, two modes may be available. In a first mode, if the desired duration of the video is shorter than the duration of a single tracking motion, the video can be obtained by taking multiple images while the tracking is active. The size of the resulting video will be that of the panchromatic strip. Where the tracking cycle is very short, multi-spectral images are taken as described above, and each multi-spectral image is used as a single frame of the video. The imaging apparatus may need to be rotated to compensate for rotations of the scene being video recorded when the scene is longer than the run length(s) of the linear actuator(s) used for tracking.

During the imaging process 700, a fine-tuning of the tracking axes and the tracking speed is performed using image processing including image correlation, such as phase correlation, as explained elsewhere within this Detailed Description. This may help correct residual yaw motion of the satellite (in embodiments employing the imaging system in a satellite-based system).

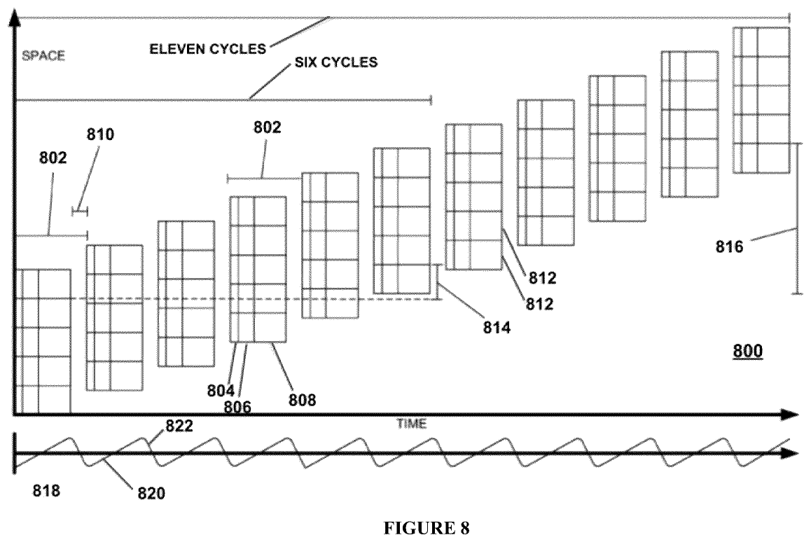

FIG. 8 is a graph 800 of cycles and exposures taken, plotted against time and space during the operation of the device during an image capture phase. In the example illustrated in FIG. 8, a series of cycles 802 result in multiple sets of exposures. Within each cycle 802, three exposures 804, 806, and 808 are made. Because the moving element(s)—at least one AID and/or at least one stabilizing optical element—is moved a length, at a speed and/or direction that compensates for the direction and speed of apparent motion of the scene being imaged, each exposure 804, 806, and 808 is of the same scene, with no displacements between them even though they occur at different times. At the end of each cycle, the moving element(s) is returned to the start position, during a time segment 810, at which point the next cycle begins. The exposures taken in successive cycles are offset from one another by an amount previously determined. Each horizontal image band 812 from each cycle 802 represents the image bands corresponding to different ones of the optical filter bands of the multi-optic filter positioned over the AID. Each successive cycle results in exposures for which a segment of the image is exposed through a different one of the filter bands. In the example illustrated in FIG. 8, five bands are present for each exposure (which may correspond to four filter bands on the multi-band optical filter plus one non-filtered band). In the example illustrated in FIG. 8, portions of image 814 have been exposed through all five filter bands. Because there is a slight offset between successive exposures, it takes more than five cycles to fully image the single band image 814 through all filter bands. After six cycles, a single band image 814 equal to the size of a single band may be stitched together. After eleven cycles, a multi-band full image 816 equal to the active area of the AID may be stitched together. Using more cycles, it is possible to compose an image stripe of arbitrary length. Longer image strips may utilize more storage, additional transmission time or bandwidth, higher compression rates, etc. Graph 818 illustrates the motion of a linear actuator for moving at least one of the moving element(s)—at least one AID and/or at least one stabilizing optical element—along a tracking axis a length, a speed and/or direction that compensates for the direction/speed of apparent motion of the scene being imaged, over the multiple cycles. For example, in a first portion 820, the AID is moved forward along the tracking axis at the tracking speed, and in a second portion 822, it is returned to the start position at a speed which may be higher than the tracking speed. If a stabilizing optical element, such as a mirror, is configured to be moved along a tracking axis, as described elsewhere within this Detailed Description, the stabilizing optical element may be moved instead of the AID, and the movement of the stabilizing optical element during a plurality of cycles will similarly result in the graph of the FIG. 8. Similarly, if one or more AIDs and one or more stabilizing optical elements are moved in a combined manner, as described elsewhere within this Detailed Description, said moving elements should be moved a length, at a speed and/or in a direction such that each exposure 804, 806, and 808 within one cycle is of the same scene, with no displacements between them even though they occur at different times, and such that the exposures taken in successive cycles are offset from one another by an amount previously determined, as seen in FIG. 8.

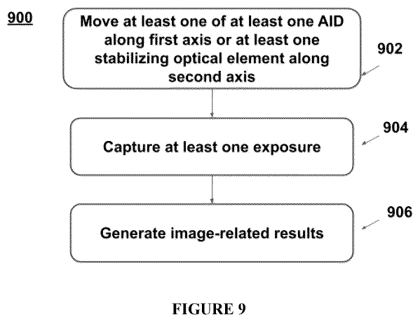

FIG. 9 shows a flowchart of an operation of an imaging system for imaging scenes in apparent motion. More specifically, a computer-implemented method 900 of operating an imaging system to image a scene having apparent motion is shown. At step 902, the method comprises controlling a positioning mechanism of the imaging system to move at least one of at least one AID along a first tracking axis or at least one stabilizing one optical element (such as a mirror) along a second tracking axis, which may be follow the same or a different direction as the first tracking axis. At step 904, the method comprises controlling the at least one area imaging device to capture at least one exposure. At step 906, the method comprises generating image-related results based at least in part on the at least one exposure.

### Example of Imaging System

An imaging system may comprise a plurality of satellites in a Low Earth orbit (LEO), at for example, 530 km high orbiting in 97 SSO. The satellites may include at least one of an imaging sensor, a substance or gas detector, such as a methane detector, on-board, a RF payload, or any other payload for data collection. In some implementations, the satellites may comprise small or low cost satellites having a sensor swath width below 100 km. In some instances, the satellites may have multiple sensors, including at least one sensor with a sensor swath width below 50 km, and even as small as 25-15 to 5 km, in order to acquire data with higher resolution, since in general the smaller the sensor swath width, the higher the sensor resolution. The satellites and/or the sensors may also swing, allowing data collection within different ranges of ONAs.

The orbit of a LEO satellite may be, for another example, 700 km high in a typical situation. At this altitude, the orbital period is 98 minutes and 37 seconds and the projected velocity on the ground is 6764 m/s. A telescope may be a Cassegrain with an aperture diameter of 30 cm and a focal length of 2.5 m. Thus, each meter on the ground will be projected as a 3.6 um image on the focal plane, and will be moving at 24.2 mm/s. The linear actuator for tracking is able to move at least at this velocity in order to compensate for the movement of the image. The maximum speed of the linear actuator for tracking may be several times higher in order to reduce the time it takes to return the linear actuator for tracking to the start position. Finally, if the camera has five filter bands and 2000×2000 pixels, each 5 μm in width, and the desired overlap between images is 100 pixels, then the run length of the linear actuator for tracking may be 1.2 mm. Each cycle will take approximately 50 ms. An approximate photometric analysis shows that exposure times would be around 10 ms in order for there to be sufficient time to take several exposures during each cycle. This can be used, as explained before, to obtain HDR and/or higher resolution images.

In this example, the cycle time can be calculated for two opposite extreme conditions. In a first extreme condition, a satellite is at the lowest LEO orbit (160 km), and has a telescope with 4 m of focal length. The cycle time will be approximately 20 ms. Providing a cycle time of 20 ms is well within the capabilities of available hardware and software components, including electronics, motors, other mechanical parts, and software, that would be reasonably suitable for implementing imaging systems as described herein, such as imaging systems onboard aircraft and spacecraft. An aperture of no more than 50 cm is needed. In a second extreme condition, a satellite is at the highest LEO orbit (2000 km) and has a telescope with 1.5 m focal length. Its cycle time will be approximately 1 second. Even with an aperture as small as 10 cm, the exposure times are several times smaller than the cycle time. This is also well within the capabilities of available components.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiment. Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B:”, “at least one of A or B:”, “one or more of A and B:”, and “A and/or B” are each intended to mean “A alone, B alone, or A and B together.” A similar interpretation is also intended for lists including three or more items. For example, the phrases “at least one of A, B, and C:”, “at least one of A, B, or C:”, “one or more of A, B, and C:” and “A, B, and/or C” are each intended to mean “A alone, B alone, C alone, A and B together, A and C together, B and C together, or A and B and C together.” In addition, use of the term “based on” above and in the claims is intended to mean “based at least in part on”, such that an unrecited feature or element is also permissible.

### Conclusion

The subject matter described herein can be embodied in systems, apparatus, methods, and/or articles depending on the desired configuration. Although the disclosure uses language that is specific to structural features and/or methodological acts, the invention is not limited to the specific features or acts described. Rather, the specific features and acts are disclosed as illustrative forms of implementing the subject matter described herein. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1-26. (canceled)

27. An apparatus for imaging a scene in apparent motion, the apparatus comprising:
at least one area imaging device having a plurality of pixel sensors;
at least one stabilizing optical element configured to receive light and reflect at least part of the received light to be received by the at least one area imaging device;
a positioning mechanism configured to move at least one of the at least one area imaging device along a first tracking axis or the at least one stabilizing optical element along a second tracking axis; and
a control module configured to control the positioning mechanism to move at least one of the at least one area imaging device along the first tracking axis or the at least one stabilizing optical element along the second tracking axis.

28. The apparatus according to claim 27, wherein the positioning mechanism is configured to move at least one of the at least one area imaging device along the first tracking axis or the at least one stabilizing optical element along the second tracking axis in one or more cycles such that at least one of the at least one area imaging device or the at least one stabilizing optical element is moved, in each of the one or more cycles, forward along each respective tracking axis at a tracking speed that compensates for a speed of the apparent motion of a scene to be imaged.

29. The apparatus according to claim 28, further comprising an imaging module, wherein the control module is configured to direct at least one of the at least one area imaging device to capture at least one exposure during each of the one or more cycles to generate one or more exposures, and wherein the imaging module is configured to form an image or video of the scene based at least in part on the one or more exposures.

30. The apparatus according to claim 29, further comprising a multi-band optical filter including a plurality of filter bands, wherein when a plurality of exposures is captured, a segment of the scene is exposed through a different one of the filter bands with successive ones of the plurality of exposures.

31. The apparatus according to claim 27, wherein at least one of a direction of the first tracking axis or a direction of the second tracking axis are such that, when the positioning mechanism moves at least one of the at least one area imaging device or the at least one stabilizing optical element, a net torque caused by the movement is parallel to a direction different than a direction of apparent motion of the apparatus.

32. The apparatus according to claim 30, wherein the control module is configured to determine at least one of the direction of the first tracking axis or the direction of the second tracking axis based at least in part on a direction towards a center of mass of the apparatus.

33. The apparatus according to claim 27, wherein the control module is configured to control the positioning mechanism to move at least one of the at least one area imaging device or the at least one stabilizing optical element such that the net torque is parallel to a direction of a center of mass of the apparatus.

34. The apparatus according to claim 27, comprising one area imaging device and one stabilizing optical element:
wherein the first tracking axis has a direction parallel to the direction of an optical axis of the apparatus and the control module is configured to control the positioning mechanism to maintain the stabilizing optical element in a fixed position such that the light is partially reflected to reach the area imaging device with a direction perpendicular to the active area of the area imaging device; or
wherein the positioning mechanism comprises one rotary actuator and the control module is configured to control the rotary actuator to rotate the stabilizing optical element about at least one axis, and/or to determine the second tracking axis to move the stabilizing optical element having a direction perpendicular to the direction of an optical axis of the apparatus, and to maintain the area imaging device in a fixed position.

35. The apparatus according to claim 27, wherein the at least one stabilizing optical element comprises a mirror or a beam splitter configured to reflect a first part of the received light towards the at least one area imaging device, and to let a second part of the received light pass towards an additional area imaging device or another element of the apparatus, wherein the first part and the second part of the light have different frequencies from each other.

36. The apparatus according to claim 27, further comprising at least one optical filter including one or more filter bands, wherein the one or more filter bands are arranged as continuously variable filter bands, discrete filter bands, filter arrays, filter mosaics, or any combination of these, the optical filter being located before the at least one area imaging device.

37. The apparatus according to claim 36, wherein the filter array comprises a repeating pattern of filters wherein each filter of the repeating pattern of filters is configured to reduce or modify the intensity of light passing through the filter so that, for each filter of the repeating pattern of filters, a pixel sensor associated with the filter receives a different amount of light, and the control module is further configured to capture exposures having different intensities, suitable to generate High Dynamic Range, HDR, images or video.

38. The apparatus according to claim 27, wherein the control module is further configured to:
direct the positioning mechanism to move at least one of the at least one area imaging device or the at least one stabilizing optical element in one or more cycles along the first tracking axis or the second tracking axis at a tracking speed that compensates for a speed of the apparent motion;
set one or more exposure times for the one or more cycles; and
direct the area imaging device to take one or more exposures at the one or more exposure times in the one or more cycles;
wherein when the one or more exposures are multiple exposures, the control module is configured to set a same exposure time for each exposure of the multiple exposures within a cycle, a different exposure time for each exposure of the multiple exposures within a cycle, or a different exposure time for a subgroup of exposures of the multiple exposures within a cycle.

39. The apparatus according to claim 27, wherein the control module is configured to control the positioning mechanism to move and/or align the first tracking axis of the at least one area imaging device and/or the second tracking axis of the at least one stabilizing optical element so as to compensate for one or more torques acting on the apparatus as a result of a movement of the at least one area imaging device and/or the at least one stabilizing optical element.

40. The apparatus according to claim 27, wherein:
the positioning mechanism is further configured to reposition at least one of the at least one area imaging device and the at least one stabilizing optical element from a first position to a second position such that the second position is offset across or along each respective tracking axis a predetermined distance from the first position; and
wherein the control module is further configured to:
direct the positioning mechanism to reposition the at least one area imaging device and/or the at least one stabilizing optical element from the first position to the second position in one or more cycles; and
direct the at least one area imaging device to take at least first exposures and at least second exposures during the one or more cycles, the first exposures corresponding to the at least one area imaging device being at the first position and the second exposures corresponding to the at least one area imaging device being at the second position; and
wherein the apparatus further comprises an imaging module configured to generate an image based at least on the first exposures and the second exposures from the one or more cycles, wherein the image is at least one of a high-resolution image, a color image, and/or a High Dynamic Range, HDR, image, or a combination of these.

41. The apparatus according to claim 27, wherein the apparatus is all or partially on-board an aircraft or spacecraft.

42. A computer-implemented method of operating an apparatus to image a scene having apparent motion, the method comprising the steps of:
controlling a positioning mechanism of an imaging system to move at least one of at least one area imaging device along a first tracking axis or at least one stabilizing optical element along a second tracking axis; and
controlling an imaging module to capture at least one exposure through the at least one area imaging device.

43. The method according to claim 42, further comprising moving at least one of the at least one area imaging device or the at least one stabilizing optical element in one or more cycles such that at least one of the at least one area imaging device or the at least one stabilizing optical element is moved, in each of the one or more cycles, forward along the respective tracking axis at a tracking speed that compensates for a speed of the apparent motion.

44. The method according to claim 42, further comprising determining at least one of a direction of the first tracking axis or and a direction of the second tracking axis based at least partially on a direction towards a center of mass of the imaging system.

45. The method according to claim 42, wherein the at least one of the direction of the first tracking axis or the direction of the second tracking axis are such that at least one of the at least one area imaging device or the at least one stabilizing optical element are moved causing a net torque to be parallel to a direction different than a direction of apparent motion of the imaging system.

46. The method according to claim 42, further comprising the steps of:
setting one or more exposure times for the one or more cycles; and
directing the area imaging device to take one or more exposures at the one or more exposure times in the one or more cycles; wherein when the one or more exposures are multiple exposures, a same exposure time is set for each exposure of the multiple exposures within a cycle, a different exposure time is set for each exposure of the multiple exposures within a cycle, or a different exposure time is set for a subgroup of exposures of the multiple exposures within a cycle.
